(19) United States
(12) Patent Application Publication
(10) Pub. No.: US 2006/0290525 A1
(43) Pub. Date: Dec. 28, 2006

(54) Gas alert for medical gas system

(76) Inventors: Donald P. Andersen, Batesville, IN (US); Edward W. Catton, New Palestine, IN (US); James P. Hentges, Fountain City, WI (US); William C. Bohlinger, Buffalo City, WI (US); Stanton H. Breitlow, Winoma, MN (US)

Correspondence Address: BARNES & THORNBURG LLP, 11 SOUTH MERIDIAN, INDIANAPOLIS, IN, 46204, US

(21) Appl. No.: 10/527,497

(22) PCT Filed: Sep. 11, 2003
(86) PCT No.: PCT/US03/28733

§ 371 Date: Mar. 11, 2005

Related U.S. Application Data
(60) Provisional application No. 60/410,092, filed on Sep. 12, 2002.

(51) Int. Cl. G08B 17/10

(52) U.S. Cl. 340/632

(57) ABSTRACT

A gas sensor module is coupled to a medical gas system in a healthcare facility to monitor gas type and/or gas flow. In some embodiments, the gas sensor module is coupled to a gas pipe of the medical gas system behind a wall, ceiling, floor, access panel, or the like and transmits an alarm signal to an alarm controller located elsewhere in the healthcare facility. In other embodiments, the gas sensor module plugs into a service outlet of the medical gas system. Also disclosed is a combination service outlet and gas sensor module. A main gas alarm module may communicate with one or more remote gas alarm modules.

This disclosure claims the benefit under 35 U.S.C. § 119(e) of U.S. Provisional Application Ser. No. 60/410,092, which was filed Sep. 12, 2002 and which is hereby incorporated by reference herein, and this disclosure is a continuation-in-part of U.S. patent application Ser. No. 09/933,502, which was filed Aug. 20, 2001 and which is hereby incorporated by reference herein.

### BACKGROUND OF THE INVENTION

The present disclosure relates to medical gas alarm systems that monitor one or more conditions of medical gas systems of healthcare facilities. More particularly, the present disclosure relates to a gas alert for a medical gas system.

Healthcare facilities, such as hospitals, include medical gas systems that deliver different types of gases and other gas-related services, such as vacuum and waste gas removal, to numerous points throughout the facility. A few examples of such gases include oxygen, nitrogen, carbon dioxide, and nitrous oxide. Conventional medical gas systems include source equipment, such as gas tanks, pumps, compressors, dryers, receivers, and manifolds that provide associated medical gases or vacuum through a network of pipes to service outlets located in rooms throughout the facility. Service outlets are usually color coded and have gas-specific connectors to prevent the wrong type of gas from being delivered to a patient or to medical equipment that connects to the service outlets with mating gas-specific connectors. However, if the gas flowing through the pipes leading to a particular service outlet is not the type of gas designated for the associated gas-specific connector, then a gas mix up may occur. This type of gas mix up is particularly undesirable for service outlets associated with breathable gas delivery.

Healthcare facilities usually include a computer network having a number of network hubs located throughout the facility. These network hubs are coupled, either directly or through other network hubs, to one or more servers of the network. The network hubs provide connection points for computer devices, such as personal computers, included in the network.

### SUMMARY OF THE INVENTION

According to this disclosure, a gas sensor module is coupled to a conduit or pipeline of a medical gas system that is designated for delivery of a particular type of gas. The gas sensor module monitors the type of gas flowing through the conduit and, if the type of gas flowing through the conduit is not the proper gas type, an alarm signal is generated to alert caregivers that the gas type is improper.

In some embodiments, the gas sensor module determines the type of gas by measuring gas content or gas concentration. The sensor in the gas sensor module that may be used to measure gas concentration may include a ceramic type of gas sensor or an ultrasonic type of gas sensor, for example. In some illustrative embodiments, the gas sensor module has a display to show the concentration of the measured gas, such as, for example, oxygen concentration. In some illustrative embodiments, the gas sensor module has a visual and/or an audible alarm to indicate that the wrong type of gas is sensed by the gas sensor module and/or that gas flow sensed by the gas sensor module is inadequate. According to some illustrative embodiments, one or more remote alarm modules are coupled electrically to the gas sensor module so that any alarms sensed by the gas sensor module are repeated where the remote alarms are located.

In one illustrative embodiment, a gas sensor module is coupled to the conduit behind a wall or ceiling of the healthcare facility and transmits to an alarm controller that is coupled to the network of the healthcare facility an alarm signal which occurs if the type of gas sensed by the module is improper. In some embodiments associated with oxygen delivery, the gas sensor module determines whether oxygen concentration is outside a predetermined range and if so, sends an alarm. In another illustrative embodiment, an oxygen concentration sensor module is configured to be coupled to an oxygen service outlet accessible in a room of the healthcare facility to monitor the oxygen concentration in an associated pipeline, thereby to monitor oxygen concentration delivered to other oxygen service outlets associated with the pipeline. In a further illustrative embodiment, an oxygen concentration sensor module is configured to be coupled to an oxygen service outlet, accessible in a room of the healthcare facility, to provide a feed-through oxygen service outlet to which patient and/or medical equipment may be coupled, and to monitor the oxygen concentration of the gas delivered through the feed-through oxygen service outlet. In yet a further illustrative embodiment, an oxygen concentration sensor module is integrated into an oxygen service outlet that is accessible in a room of the healthcare facility. In some embodiments in which an oxygen concentration sensor module couples to or is integrated into an oxygen service outlet an audible alarm is sounded by providing an alarm signal toga speaker, buzzer, horn, or the like included in the oxygen concentration sensor module and, in other embodiments, an alarm signal is sent to a separate alarm controller either directly or via the hospital network.

Illustratively, the oxygen concentration sensor module includes a housing and an oxygen sensor, for example a ceramic or ultrasonic oxygen sensor. The housing is couplable to the gas line of the medical gas system to expose the oxygen sensor to the oxygen flowing in the gas line. The sensor is configured to generate a concentration signal that indicates the oxygen concentration of the gas present in the gas line. The sensor module further includes an electric circuit coupled to the housing. The electric circuit receives and processes the concentration signal from the oxygen sensor.

Each of the embodiments described herein as measuring oxygen concentration may be configured alternatively to measure the concentrations of other types of gases, including breathable gases such as an oxygen and carbon dioxide mixture, medical air, and nitrous oxide, as well as non-breathable gases.

Additional features and advantages of the invention will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a diagrammatic view of a healthcare facility having a medical gas system and a network of computer devices showing various components of a medical gas alarm system coupled to the medical gas system and coupled to the network;

FIG. 2 is a diagrammatic view of the network and the medical gas alarm system of FIG. 1 showing a server of the network and several network hubs of the network surrounded by a dashed box, a pair of area alarm controllers above the dashed box, two sets of three sensor modules above the area alarm controllers with each set including an oxygen concentration sensor module and two gas pressure sensor modules, each sensor module being coupled pneumatically to a respective gas line of the medical gas system and coupled electrically to an associated area alarm controller, a first master alarm controller beneath the dashed box, a second master alarm controller to the right of the dashed box, the area alarm controllers and the master alarm controllers each being coupled electrically to a respective network hub, a personal computer of the network coupled to the server through an associated network hub, and a personal computer external to the network coupled to the server via the world wide web;

FIG. 3 is a front elevation view of a portion of one of the master alarm controllers of FIG. 2 showing a 3-by-3 array of LED's, each LED being labeled to correspond to a type of gas or gas-related service of the medical gas'system, an alarm silence button and a test button beneath the array of LED's, and a display screen above the array of LED's;

FIG. 4 is a perspective view of a portion of the master alarm controller of FIG. 3 showing a door panel of the master alarm controller moved to an opened position relative to a rough-in box of the master alarm controller to provide access to various electric circuit components of the master alarm controller;

FIG. 5 is a front elevation view of a portion of one of the area alarm controllers of FIG. 2 showing three display modules, the rightmost of which displays a number indicating the oxygen concentration in an associated gas line and the two others of which display a number indicating the gas pressure in associated gas lines of the medical gas system;

FIG. 6 is a perspective view of a portion of the area alarm controller of FIG. 4 showing a door panel of the area alarm controller moved to an opened position relative to a rough in box of the area alarm controller to provide access to various electric circuit components of the area alarm controller;

FIG. 7 is a front elevation view of a local alarm annunciator included in the medical gas alarm system showing the local alarm annunciator having a 2-by-8 array of LED's, a test button beneath the array of LED's, and an alarm silence button beneath the array of LED's;

FIG. 8 is a perspective view of the local alarm annunciator of FIG. 7 showing a front panel of the local alarm annunciator disconnected from a wall-mountable box of the local alarm annunciator to provide access to various electrical components of the local alarm annunciator;

FIG. 9 is an exploded perspective view showing components of one of the pressure sensor modules included in the medical gas alarm system and showing components that couple the sensor module pneumatically to one of the gas lines of the medical gas system;

FIG. 10 is an exploded perspective view showing components of a gas sensor module included in the medical gas alarm system that utilizes a ceramic gas sensor to sense gas type and showing components that couple the gas sensor module pneumatically to one of the oxygen gas lines of the medical gas system;

FIG. 11 is a diagrammatic view of an electric circuit included in the gas sensor module of FIG. 10 showing that, in this example, the circuit has a ceramic oxygen sensor for the monitoring of oxygen concentration;

FIG. 12 is an exploded perspective view showing components of an alternative gas sensor module included in the medical gas alarm system that utilizes an ultrasonic gas sensor configured to sense gas type and gas flow and showing components that couple the gas sensor module pneumatically to one of the gas lines of the medical gas system;

FIG. 13 is a diagrammatic view of an electric circuit included in the gas sensor module of FIG. 12 showing that, in this example, the circuit has an ultrasonic oxygen sensor for the monitoring of oxygen concentration;

FIG. 14 is a perspective view showing another embodiment of a gas sensor module, in the lower right corner of the Fig., configured to be coupled to a first oxygen service outlet mounted on a wall of a room, a connector of a piece of medical equipment configured to be coupled to a second oxygen service outlet mounted to the wall, and the first and second oxygen service outlets being coupled to a common gas line of a medical gas system;

FIG. 15 is a perspective view showing yet another embodiment of a gas sensor module configured to be coupled to an oxygen service outlet mounted to a wall of a room and configured to provide a feed-through oxygen service outlet for the coupling of healthcare equipment that receives oxygen flowing through the gas sensor module;

FIG. 16 is a perspective view showing a further embodiment of a gas sensor module mounted to a wall of a room and having an integrated oxygen service outlet for the coupling of healthcare equipment that receives oxygen flowing through the gas sensor module;

FIG. 17 is a diagrammatic view showing a medical gas system having a manifold which receives a supply of gas from a number of gas tanks, a main gas outlet line extending from the manifold to a hospital piped network of gas lines, a pressure gage and a main gas alarm module coupled to the main gas outlet, and at least one remote gas alarm module coupled electrically to the main alarm;

FIG. 18 is a diagrammatic view showing the main gas alarm module having a pair of ultrasonic gas sensors that receive a sample of gas from the main gas outlet line, the main gas alarm module and the at least one remote gas alarm module each having visual and audible alarms to indicate improper gas type, inadequate gas flow, and other fault conditions, and the main gas alarm module being in electrical communication with the at least one remote gas alarm module;

FIG. 19 is a perspective view of a housing of the main gas alarm module;

FIG. 20 is a perspective view of a housing of the at least one remote gas alarm module mounted to a wall;

FIG. 21 is a block diagram showing a main gas alarm in pneumatic communication with a gas pipe through a DISS fitting, a filter, and an orifice, showing the main gas alarm being in electrical communication with a number of remote alarms, a building automation system, and a first master alarm controller which is coupled to a computer network, and showing a second master alarm controller coupled to one of the remote alarms and to the computer network;

FIG. 22 is a block diagram showing details of the electric circuitry and the pneumatic circuitry of the main gas alarm module; and

FIG. 23 is a block diagram showing details of the electric circuitry of one of the remote gas alarm modules.

### DETAILED DESCRIPTION OF THE DRAWINGS

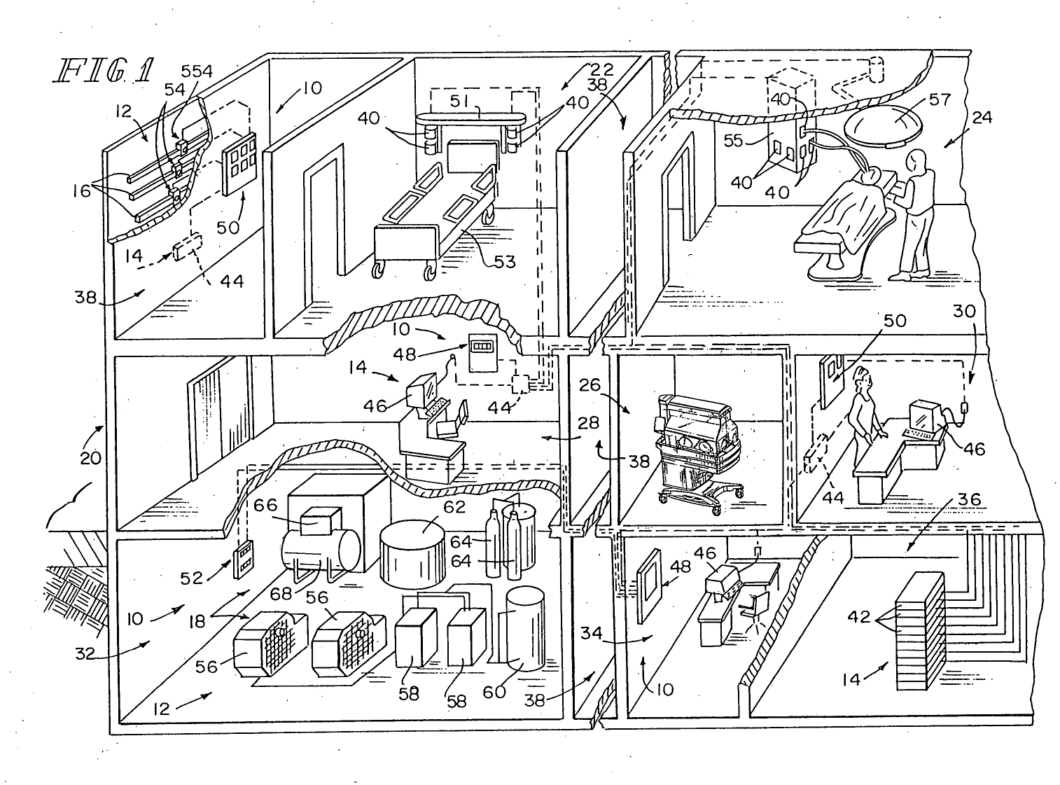

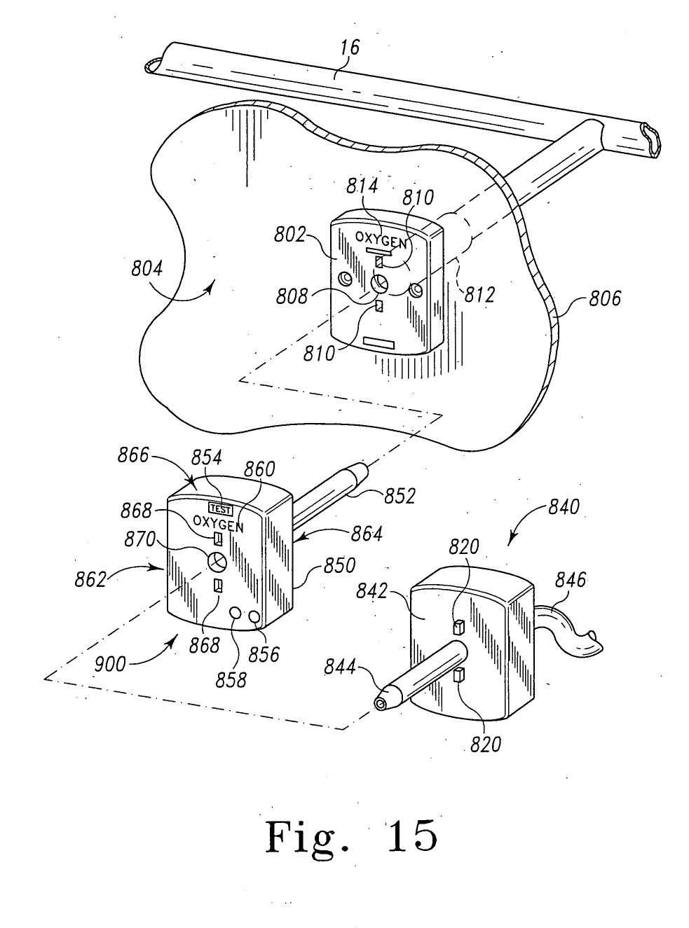

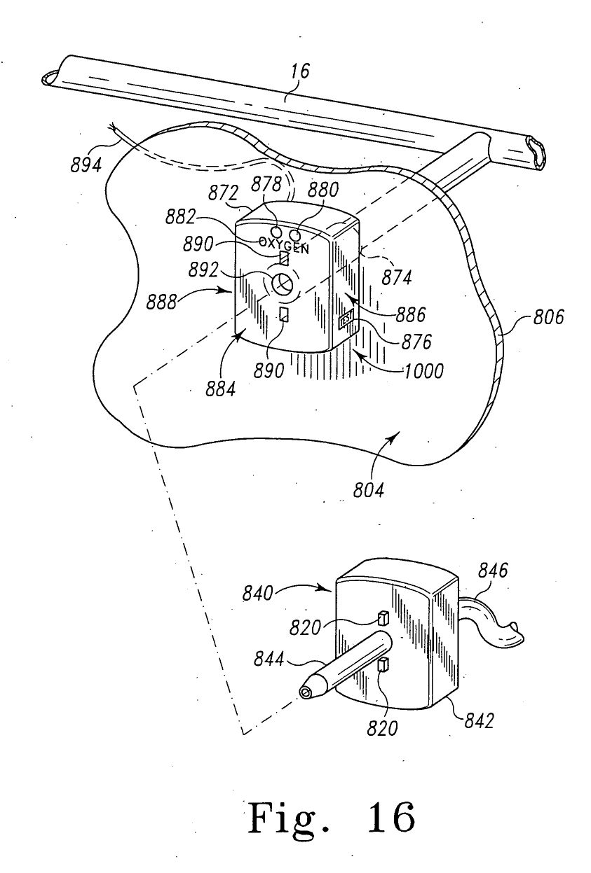

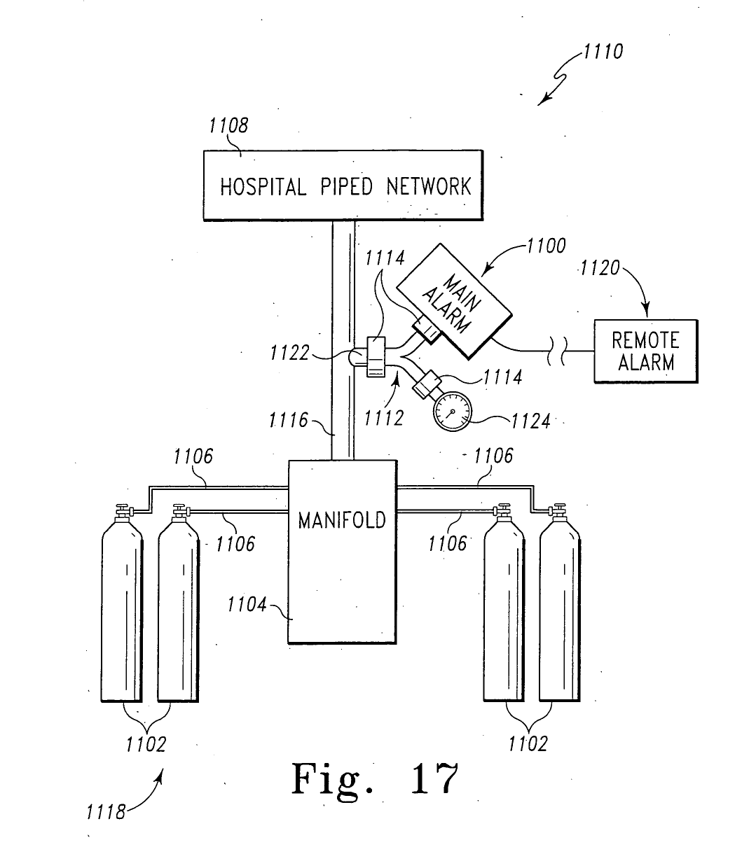

A number of illustrative gas sensor modules are described herein. A gas sensor module 554, shown in FIGS. 1, 2, 10, and 12, is coupled to the conduit behind a wall or ceiling of a healthcare facility. A sensor module 800, shown in FIG. 14, is configured to be coupled to an oxygen service outlet accessible in a room of the healthcare facility. A sensor module 900, shown in FIG. 15, is configured to be coupled to an oxygen service outlet accessible in a room of the healthcare facility and provide a feed-through oxygen service outlet. A sensor module 1000, shown in FIG. 16, is integrated into an oxygen service outlet that is accessible in a room of the healthcare facility. A main gas sensor module 1100, shown in FIGS. 17-19, 21 and 22, is coupled pneumatically to a main gas outlet line 1116 adjacent a main gas supply 1118 and communicates electrically with at least one remote gas alarm module 1120, shown in FIGS. 17, 18, 20, 21, and 23.

In several of the examples which are described herein, a gas sensor module is described as sensing oxygen concentration. However, gas sensor modules in accordance with this disclosure may be configured to sense the gas concentration of any type of gas including non-breathable gases and breathable gases such as, for example, medical air, a mixture of oxygen and carbon dioxide, and nitrous oxide. In addition, gas sensor modules in accordance with this disclosure may sense any one or more of gas content, gas type, gas concentration, and/or gas flow. It should be appreciated that sensing gas concentration is a'specific way to sense gas type and/or gas content.

According to this disclosure, a medical gas alarm system 10 is provided for use in a healthcare facility, such as a hospital. Hospitals are usually large, multi-story buildings having a multitude of rooms that are grouped into various wings, units, or wards. Such a facility 20 is shown diagrammatically in FIG. 1 as having a patient room 22, an operating room 24, a neonatal intensive care unit 26, a security station 28, a nurse station 30, a mechanical equipment room 32, a facilities engineer office 34, a main computer room 36, and a number of corridors 38 interconnecting these rooms and units. Although facility 20 is shown diagrammatically as having only one patient room 22, one operating room 24, etc., hospitals typically have more than one of each of these rooms, as well as having, for example, intensive care units, critical care units, recovery rooms, maternity wards and so on. Thus, it will be appreciated that FIG. 1 is intended to provide a general understanding of the basic environment in which alarm system 10 is used and to provide a general understanding of the interaction of the components of alarm system 10 with other components included in a healthcare facility.

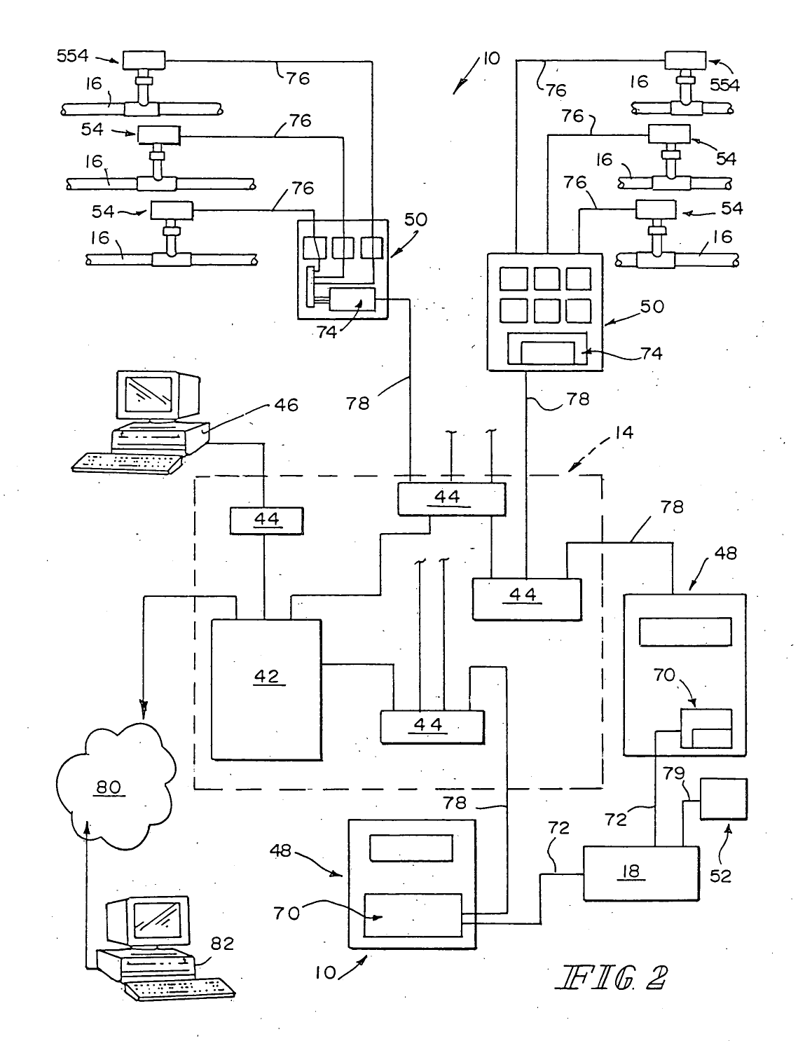

Facility 20 has a medical gas system 12 and an Ethernet or network 14 of computer devices. Alarm system 10 couples to gas system 12 and to network 14 as will be described in further detail below. The computer devices in network 14 include one or more servers 42, a plurality of network hubs 44, and one or more personal computers 46 as shown in FIGS. 1 and 2. Server 42 and personal computers 46 communicate with each other through hubs 44 in a manner well known to those skilled in the art.

Medical gas system 12 includes various pieces of source equipment 18 located in room 32 and a network of pipes or lines 16 that are routed throughout facility 20 as shown in FIG. 1. Source equipment 32 operates to deliver different types of gases and gas-related services through lines 16 to associated service outlets 40 located at different points throughout facility 20. For example, some outlets 40 are located in room 22 on a headwall unit 51 that is adjacent a patient bed 53 and some outlets 40 are located in room 24 on a column 55 that extends downwardly from the ceiling adjacent a surgical light 57.

Alarm system 10 monitors various conditions occurring at different points in gas system 12 and provides both a visual alarm and an audible alarm when an alarm condition is detected. In preferred embodiments, the points in gas system 12 that are monitored by alarm system 10 are in accordance with standards set by the National Fire Protection Association (NFPA). See, for example, NFPA 99, Standard for Health Care Facilities, 1999 Edition. Illustrative alarm system 10 includes two master alarm controllers 48 which provide redundant monitoring of conditions occurring in source equipment 18. One of illustrative master alarm controllers 48 is located in facilities engineer office 34 and the other of illustrative master alarm controllers 48 is located at security station 28. Alarm system 10 also includes a number of area alarm controllers 50 that monitor one or more of the following: gas pressures in lines 16, gas type in lines 16, gas flow in lines 16, and gas concentration levels in lines 16. Illustrative alarm system 10 includes two area alarm controllers 50, one located at nurse station 30 and one located in the corridor 38 adjacent to patient room 22. It will be appreciated that a typical healthcare facility will have many more than two area alarm controllers 50. Alarm system 10 farther includes a local alarm annunciator 52 located in mechanical equipment room 32 and a plurality of pressure sensor modules 54 and gas sensor modules 554 that operate to measure one or more of the following: gas pressure, gas type, gas flow, and gas concentration levels in associated lines 16 and operate to provide a signal to an associated area alarm controller 50.

Source equipment 18 of medical gas system 12 includes, for example, compressors 56, dryers 58, receivers 60, liquid storage tanks 62, gas tanks 64, vacuum pumps 66, and vacuum tanks 68 as shown diagrammatically in FIG. 1. Source equipment 18 also includes a number of other pieces of auxiliary equipment (not shown) such as, for example, manifolds, filters, and valves. Source equipment 18 operates to distribute the various types of gases and gas-related services to associated lines 16 in a manner well known to those skilled in the art.

The various pieces of source equipment 18 are outfitted by their manufacturers with a number of switches (not shown) that change from one state, such as an OFF or low state, to another state, such as an ON or high state, to indicate the occurrence of certain conditions in source equipment 18. Some of these switches include, for example, pressure switches that are configured to change state when pressures in associated lines, pipes, or conduits become either too high or too low, as the case may be. Others of these switches include, for example, liquid level sensors with circuitry that produces output signals that change state when the liquid level in an associated tank 62 drops to a predetermined level or when the liquid level in an associated receiver 60 rises to a predetermined level. Still others of these switches change state when a reserve supply or a second supply of gas is being used instead of a main supply. Source equipment 18 may also include switches that change state as the result of the occurrence of other conditions, such has high dew point, equipment malfunction, high temperature, low temperature, inappropriate chemical concentration, and use of a back-up pump or compressor.

Exemplary gases and gas-related services delivered by source equipment 18 include oxygen, nitrogen, medical air, medical vacuum, nitrous oxide, waste anesthesia gas disposal (WAGD), carbon dioxide, oxygen/carbon dioxide mixture, helium, and argon. Medical air is sometimes referred to as laboratory air or dental air if being used for laboratory or dental purposes, respectively. Similarly, medical vacuum is sometimes referred to as laboratory vacuum or dental vacuum. Other gases or gas-related services may be provided by source equipment 18 for other specialized purposes.

The medical purpose of each gas and gas-related service delivered by source equipment 18 is different. For example, oxygen is sometimes delivered to patients to increase their blood oxygenation, nitrogen is sometimes used to power tools in the operating room, medical air is filtered air that is used to assist patient respiration, medical vacuum is sometimes used during surgery to suction blood and other fluids away from the patient, nitrous oxide is sometimes administered by anesthesiologists to patients during surgery, the WAGD system is sometimes used to remove gases exhaled by patients during surgery, and helium is sometimes used during laparoscopic or endoscopic procedures to inflate certain areas within a patient's body to provide room for surgical instruments that are used during these procedures.

Because various pieces of source equipment 18 operate to deliver associated gases or gas-related services (hereinafter referred to collectively as “service” or “services”) through an associated subset of lines 16, medical gas system 12 includes a number of subsystems, each of which is associated with the delivery of a particular service. Furthermore, in large healthcare facilities, medical gas system 12 may include more than one'subsystem of source equipment 18 and lines 16 that deliver the same type of service to different parts of the facility. Thus, it is not uncommon for medical gas systems included in large healthcare facilities to have more than one oxygen subsystem, more than one medical vacuum subsystem, and so on.

Each master alarm controller 48 includes an electric circuit 70 that receives one or more input signals from the switches of associated pieces of source equipment 18 via electrical conductors or lines 72 as shown diagrammatically in FIG. 2. In accordance with standards set by the NFPA, at least two redundant master controllers 48 are provided to monitor the same conditions of source equipment 18. Thus, the master alarm controller 48 at station 28 monitors the same conditions of source equipment 18 as are being monitored by the master alarm controller 48 in office 34.

Each area alarm controller 50 includes an electric circuit 74 that receives input signals from each respective pressure sensor module 54 and gas sensor module 554 via electrical conductors or lines 76. Electric circuits 70, 74 are microcontroller or microprocessor-based circuits that process the respective input signals and determine whether the input signals are indicative of alarm conditions in gas system 12. Circuits 72, 74 of alarm controllers 48, 50, respectively, are configured to be coupled to network 14 via associated electrical conductors 78 as shown diagrammatically in FIG. 2. In addition, local alarm annunciator 52 receives input signals from the switches of associated pieces of source equipment 18 via electrical conductors or lines 79. In some embodiments, conductors 72, 76, 79 are shielded, twisted pairs and conductors 78 are RJ-45 cables.

Area alarm controllers 50 communicate with master alarm controllers 48 through server 42 and through respective hubs 44 of network 14. Some of hubs 44 are coupled directly to server 42 and some hubs 44 are included in chains of two or more hubs 44 that couple to server 42 as shown diagrammatically in FIG. 2. Illustrative network hubs 44 are configured to couple to a number of computer devices. Thus, the network hubs 44 to which any of alarm controllers 48, 50 couple may also be coupled to one or more personal computers 46, for example. In alternative embodiments, one or more of alarm controllers 48, 50, as well as one or more of personal computers 46, may be coupled directly to server 42. Server 42 operates in a conventional manner to control the flow of data between the various computer devices coupled to server 42 either directly or via hubs 44.

Each area alarm controller 50 communicates data through network 14 to master alarm controllers 48, including data regarding the pressures sensed by the respective pressure sensor modules 54 and data regarding the gas type, gas flow, and/or gas concentration levels sensed by the respective gas sensor modules 554 associated with each of the area alarm controllers 50. Each master alarm controller 48 caches the data received from the area alarm controllers 50 in memory devices included in respective electric circuits 70. In addition, electric circuit 74 of each area alarm controller 48 has its own memory devices in which data is stored, including data regarding the gas pressures, gas type, gas flow, and/or gas concentration levels sensed by the associated sensor modules 54, 554. Furthermore, master alarm controllers 48 and area alarm controllers 50 communicate identifying information to each other through network 14 so that each master alarm controller 48 is made aware of all of the other alarm controllers 48, 50 that are coupled to network 14 and so that each area alarm controller 50 is made aware of the master alarm controllers 48 that are coupled to network 14.

Alarm controllers 48, 50 are each programmed to host or serve a website. In one embodiment, area alarm controllers 50 are each identified by different network addresses and the master alarm controllers 48 are all identified by the same network address. Thus, in this embodiment, master alarm controllers 48 host a single website and area alarm controllers 50 each host their own separate websites. In other embodiments, area alarm controllers 50 are all identified by a single network address and cooperate with each other to host a single website. In still other embodiments, all of the alarm controllers 48, 50 are identified by the same network address such that the alarm controllers 48, 50 cooperate with one another to host a single website. It is also within the scope of this disclosure for each master alarm controllers 48 to be identified by a different network address and to host a. website separate from each of the other master alarm controllers 48.

Once alarm controllers 48, 50 are coupled to network hubs 44 and are properly configured with network addresses, alarm controllers 48, 50 become part of the Ethernet 14 of facility 20 and the websites hosted by alarm controllers 48, 50 are accessible to any of personal computers 46 that are included in network 14 and that are programmed with conventional web browser software. In addition, if network 14 is coupled to the world wide web or Internet, which is illustrated diagrammatically in FIG. 2 at reference numeral 80, then the websites hosted by alarm controllers 48, 50 are accessible to any remote personal computers 82 that are coupled to the Internet 80 and that are programmed with conventional web browser software.

The description below of the various components and the operation of the components of one illustrative master alarm controller 48 is applicable to all illustrative master alarm controllers 48 unless specifically noted otherwise. Similarly, the description below of the various components and the operation of the components of one illustrative area alarm controller 50 is applicable to all illustrative area alarm controllers 50 unless specifically noted otherwise. Likewise, the description below of the components and the operation of components of one illustrative pressure sensor module 54 is applicable to all illustrative pressure sensor modules 54 unless specifically noted otherwise. Additionally, the description below of the components and the operation of components of one illustrative gas sensor module 554 is applicable to all illustrative gas sensor modules 554 unless specifically noted otherwise.

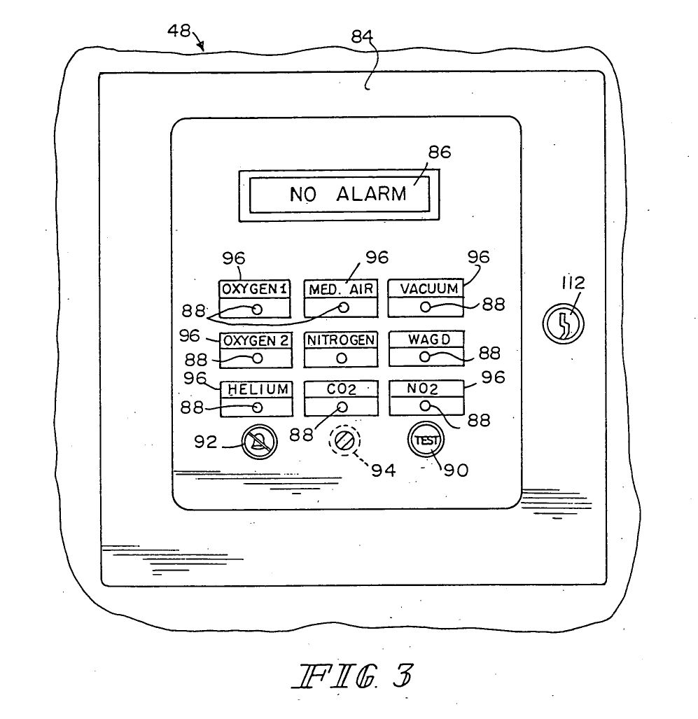

Master alarm controller 48 includes a panel 84, a display screen 86 coupled to panel 84, and a plurality of light emitting diodes (LED's) 88 coupled to panel 84 as shown in FIG. 3. Alarm controller 48 also includes a test button 90 and an alarm silence button 92 that are accessible on the front of panel 84. Display screen 84, LED's 88, test button 90, and alarm silence button 92 are some of the components included in electric circuit 70. A set of labels 96 are attached to panel 84, each label 96 being positioned adjacent a respective LED 88 and each label 96 indicating the subsystem of gas system 12 that is associated with the respective LED 88. In the illustrative embodiment, nine LED's 88 are provided on panel 84. If more than one subsystem of gas system 12 delivers the same type of service, then labels 96 may be fashioned in such a manner to indicate this, as is shown in FIG. 3 where the LED 88 associated with a first oxygen subsystem is labeled as “OXYGEN 1” and the LED 88 associated with a second oxygen subsystem is labeled as “OXYGEN 2.”

When an alarm condition occurs anywhere in gas system 12 and is detected by alarm system 10, display screen 86 and the LED 88 associated with the subsystem of gas system 12 in which the alarm condition is occurring operate to provide visual indicators of the occurring alarm condition. For example, in one embodiment, a text message providing information about the alarm condition is displayed on display screen 86 and the LED 88 associated with the subsystem in which the alarm condition is occurring changes from green to red and flashes. In this embodiment, if more than one alarm condition occurs in gas system 12, then the text messages displayed on display screen 86 alternate or scroll every so often, such as every two seconds, to provide information about the various alarm conditions. In other embodiments, display screen 86 is configured to display simultaneously a plurality of text messages to convey information about a plurality of alarm conditions occurring in gas system 12. If no alarm conditions are detected by alarm system 10, then screen 86 will display an appropriate message, such as “NO ALARM,” as shown in FIG. 3

If more than one alarm condition occurs in gas system 12, then more than one of LED's 88 will visually indicate the occurring alarm conditions by flashing red, assuming that the alarm conditions occur in different subsystems of gas system 12. If more than one alarm condition occurs in the same subsystem of gas system 12, then the one LED 88 associated with the subsystem in which the multiple alarm conditions are occurring will be activated to flash red to provide the visual alarm. Electric circuit 70 also includes a speaker 94 or other suitable sound-producing device that is activated to provide an audible alarm when an alarm condition is sensed anywhere in gas system 12 by alarm system 10. Speaker 94 may be silenced by pressing button 92. In addition, pressing button 92 acknowledges all of the then existing alarm conditions and causes the associated LED's 88 to stay steadily lit instead of flashing. Each new alarm condition resounds the audible alarm and causes the associated LED 88 to flash red, while the LED's 88 of the previously acknowledged alarm conditions remain steadily lit. In some embodiments, electric circuit 70 is programmed so that the audible alarm generated by speaker 94 resounds after a predetermined period of time, assuming the alarm condition is still occurring after the predetermined period of time.

When test button 90 is pressed, electric circuit 70 of alarm controller 48 runs a self-diagnostic test routine. For a short period of time after the diagnostic test routine starts, all of LED's 88 light; the characters of display screen 86 illuminate, and speaker 94 is activated to sound the audible alarm. Thereafter, a list of text messages for the configured alarms scrolls on display screen 86. If a problem is detected by electric circuit 70 while running the self-diagnostic test, then appropriate error messages are provided on display screen 86 after the test is finished. Of course, if screen 86 fails the diagnostic test and is unable to display any information at all, this will be readily apparent since screen 86 will be blank.

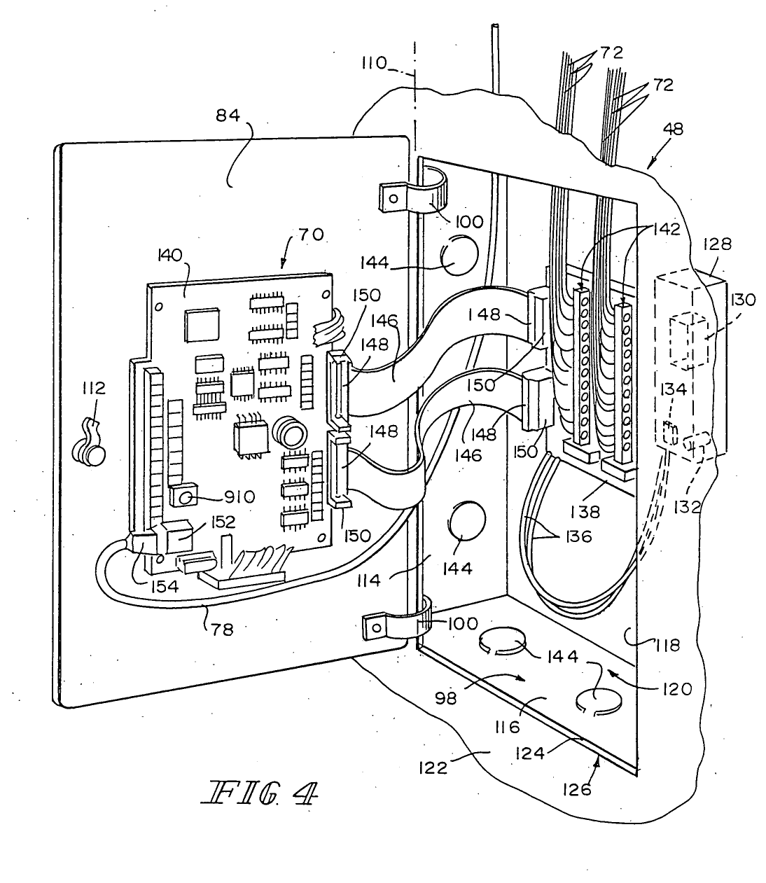

Master alarm controller 48 includes a box 98 and a pair of hinge mechanisms 100 that couple panel 84 to box 98 for pivoting movement about a vertical axis 110 as shown in FIG. 4. Box 98 cooperates with panel 84 to provide a housing 84, 98 of controller 48. A locking device 112 is coupled to panel 84 and is operable to lock panel 84 in a closed position relative to box 98 and to unlock panel 84 for movement about axis 110 between the closed position and an opened position. Thus, panel 84 serves as a door of alarm controller 48.

Box 98 includes side panels 114, end panels 116, and a back panel 118. Panels 114, 116, 118 define an interior region 120 of box 98. Box 98 includes a front panel 122 that is parallel with back panel 118. Panel 122 includes a rectangular edge 124 that defines an opening 126 through which interior region 120 of box 98 is accessed when panel 84 is in the opened position. Panels 114, 116 extend perpendicularly between panels 118, 122. Box 98 is configured so that panels 114, 116, 118 are receivable in an appropriately sized cavity or recess formed in a wall of a facility and so that portions of panel 122 extending perpendicularly outwardly from panels 114, 116 abut the wall of the facility to which alarm controller 48 is mounted.

Electric circuit 70 of master alarm controller 48 includes a power supply 128 that is mounted to back panel 118. Power supply 128 includes a transformer 130, a fuse holder 132, and an ON/OFF switch 134; Power supply 128 receives standard 110 Volt, 60 Hertz power from the healthcare facility and operates in a conventional manner to provide electrical power to the rest of circuit 70 via power lines 136. ON/OFF switch 134 is placed in an ON position during the normal operation of master alarm controller 48 and may be placed in an OFF position during installation, removal, or maintenance of electric circuit 70. Fuse holder 132 contains a fuse (not shown) that operates in a conventional manner to provide electrical protection for circuit 70.

Electric circuit 70 further includes a breakout board 138 mounted to back panel 118 and a main circuit board 140 mounted to panel 84 as shown in FIG. 4. Power lines 136 are coupled to breakout board 128 via suitable electrical connectors (not shown) well-known to those skilled in the art. Board 138 includes a pair of connector banks 142 that provide a plurality of input ports for circuit 70. In the illustrative embodiment, each connector bank 142 is configured with fifteen input ports and therefore, illustrative circuit 70 includes a total of thirty input ports. In other embodiments, a different number of input ports are provided. Each input port includes two wire connection points, one for each wire of the twisted wire pairs that comprise conductors 72. Panels 114, 116 each include one or more tabs 144 that are punched out to provide corresponding apertures in panels 114, 116 through which conductors 72 are routed to reach connector banks 142.

Electric circuit 70 includes a pair of ribbon cables 146 that electrically couple breakout board 138 to main circuit board 140. Connectors 148 at the opposite ends of each ribbon cable 146 mate with corresponding connectors 150 of respective boards 138, 140. Input signals provided from the various switches of source equipment 18 on conductors 72 are communicated from board 138 to board 140 by ribbon cables 146. In addition, power is provided to board 140 from board 138 via ribbon cables 146. By having panel 84 pivot about vertical axis 110 between the closed and opened positions, rather than having panel 84 pivot downwardly about a horizontal axis at the bottom of panel 84, as is the case with some prior art alarm controllers, ribbon cables 146 do not lay across circuit 70 which reduces the risk of ribbon cable 146 short circuiting components of circuit 70.

Board 140 of circuit 70 carries a number of electrical components, including integrated circuit chips that are shown and described in U.S. patent application Ser. No. 09/933,502, which is hereby incorporated by reference herein. Display screen 86 and LED's 88 are coupled to board 140 and are positioned and arranged on board 140 so as to be visible through corresponding openings formed in panel 84 when board 140 is attached to the back of panel 84 as shown in FIG. 4. Board 140 includes a communication port 152. A connector 154 at an end of conductor 78 couples to port 152. Conductor 78 is routed from port 152, through interior region 120 of box 98, through one of the apertures that are created in panels 114, 116 of box 98 when tabs 144 are punched out, and to one of network hubs 44. Thus, data is provided to circuit 70 from network 14 through port 152 and data is provided from circuit 70 to network 14 through port 152.

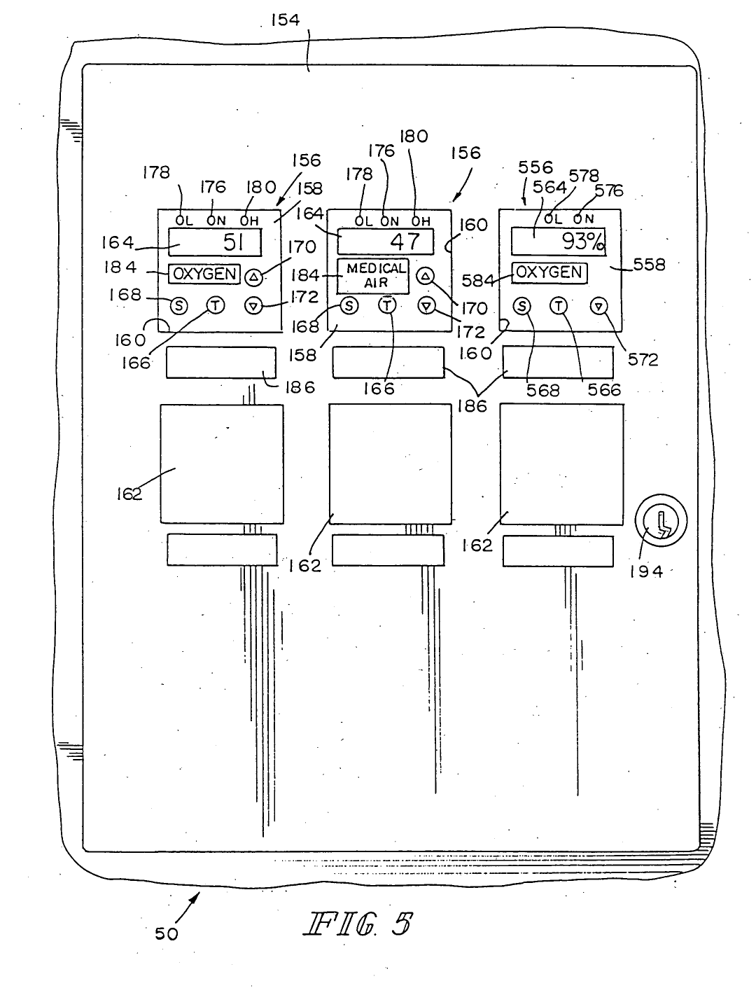

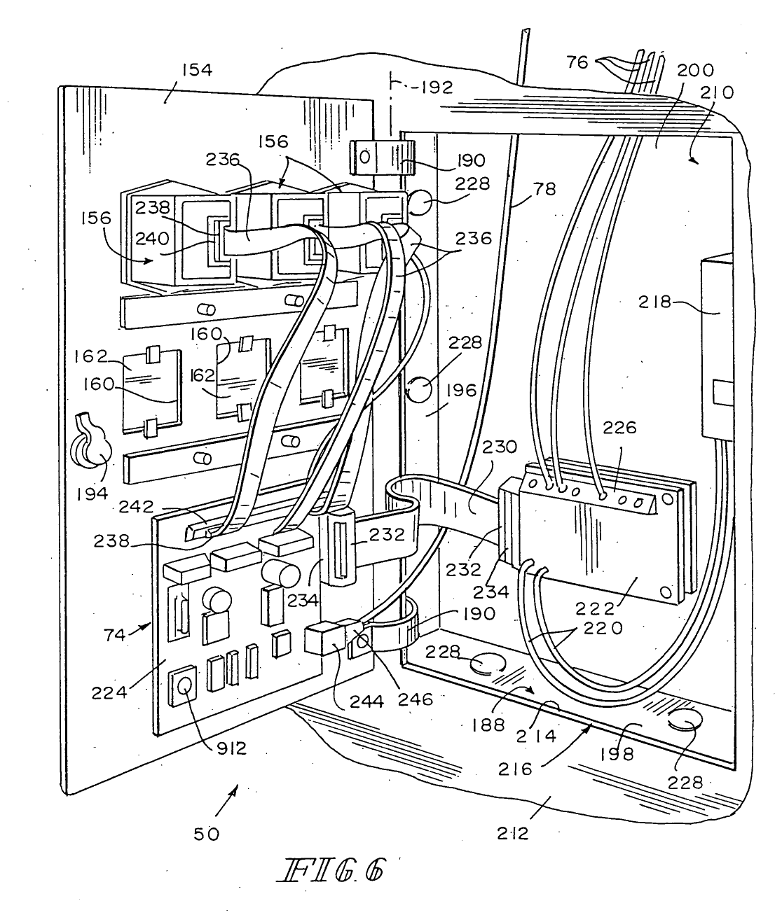

Area alarm controller 50 includes a panel 154, one or more pressure display modules 156 that couple to panel 154, and one or more concentration display modules 556 that couple to panel 154 as shown in FIGS. 5 and 6. Each, display module 156, 556 has a front face 15.8, 558, respectively, that appears in a respective opening or window 160 formed in panel 154 as shown in FIG. 5. In the illustrative embodiment, panel 154 is configured to accommodate a combination of up to six display modules 156, 556. If less than six display modules 156, 556 are included in illustrative alarm controller 50, then an appropriate number of filler plates 162 are coupled to panel 154 to block associated openings 160. For example, the controller 50 shown in FIG. 5 has two pressure display modules 156, one concentration display module 556, and three filler plates 162.

Although in the illustrative embodiment each display module 156, 556 measures a gas pressure or a gas concentration, respectively, it is contemplated that the functions of pressure display module 156 and concentration display module 556 may be combined into a single display module having the capabilities to display a variety of information including a gas pressure and a gas concentration level.

In the illustrative embodiment, each pressure display module 156 is associated with a respective pressure sensor module 54 and includes a display screen 164 on which numeric pressure readings are displayed. Similarly, in the illustrative embodiment, each concentration display module 556 is associated with a respective gas sensor module 554 and includes a display screen 564 on which numeric gas concentration readings are displayed. The pressure readings correspond to the gas pressures existing in the respective lines 16 to which modules 54 are coupled. The concentration readings correspond to the gas concentration on a percentage basis existing in the respective lines to which modules 554 are coupled. The units of pressure and concentration measurement, such as pounds per square inch (psi) for pressure, are indicated, in some embodiments, by a label or other suitable indicia (not shown) on front face 158, 558 adjacent screen 164, 564 and, in other embodiments, by text (not shown) that appears on screen 164, 564 alongside the measurement readings.

Each display module 156, 556 includes a test button 166, 556 and an alarm silence button 168, 568, respectively, as shown in FIG. 5. Display module 156 also includes an up arrow button 170 and a down arrow button 172. Illustrative display module 556 includes only a down arrow button 572 although, in some embodiments, display module 556 may include an up arrow button as well. Each of buttons 166, 168, 170, 172 and buttons 556, 568, 572 are coupled to the front face 158, 568 of the respective display module 156, 556 and are accessible in window 160.

Each pressure display module 156 includes a “normal” LED 176 that shines green when the gas pressure in the associated line 16 is within an acceptable range, a “low” LED 178 that shines red when the gas pressure in the associated line 16 is below a minimum acceptable pressure, and a “high” LED 180 that shines red when the gas pressure in the associated line 16 is above a maximum acceptable pressure. Each concentration display module 556 includes a “normal” LED 576 that shines green when the gas concentration in the associated line 16 is greater than a predetermined minimum concentration, for example, 95% oxygen concentration in the case of oxygen concentration measurement, and a “low”-LED 578 that shines red when the gas concentration in the associated line 16 is below the predetermined concentration.

Each display module 156 includes an electric circuit that is programmed for a specific gas or gas-related service. That is, depending upon what type of gas or gas-related service of gas system 12 is to be monitored by a particular display module 156, certain parameters, such as gas type, units of measure, high alarm point, and low alarm point, are stored in memory devices included in the electric circuit of the associated display module 156. By way of example, the standards set by the NFPA for the nominal pressure in lines 16 for each of the oxygen, medical air, nitrous oxide, oxygen/carbon dioxide mixture, carbon dioxide, and helium subsystems of gas system 12 is 50 psi (345 kPa) with a tolerance of +5 psi, −0 psi (+35 kPa, −0 kPa), the high alarm point is set 20% above the nominal pressure, and the low alarm point is set 20% below the nominal pressure. Standards for the nominal pressures and alarm points for other subsystems of gas system 12, such as for the nitrogen, vacuum, and WAGD subsystems, are also established by the NFPA.

The electric circuit of each pressure display module 156 or, alternatively, circuit 74 includes a speaker (not shown) or other suitable sound-producing device that provides an audible alarm when any one or more of the input signals from pressure sensor modules 54 indicates that the pressure existing in the respective line 16 is outside an acceptable range of pressures. To determine the range of acceptable pressures, a user may press up arrow button 170 to cause the numerical value of the pressure associated with the high alarm point to be displayed on screen 164 and the user may press the down arrow button 1.72 to cause the numerical value of the pressure associated with the low alarm point to be displayed on screen 164. Buttons 166, 168, 170, 172, LED 's 176, 178, 180, and display screen 164 of each module 156 are some of the components included in the electric circuit of the respective module 156.

Similarly, the electric circuit of each concentration display module 556 includes a speaker (not shown) or other suitable sound-producing device that provides an audible alarm when any one or more of the input signals from gas concentration sensor modules 554 indicates that the gas concentration existing in the respective line 16 is below an acceptable level. To determine the level of acceptable concentration, a user may press the down arrow button 572 to cause the numerical value of the concentration level associated with the low concentration alarm point to be displayed on screen 564. In some embodiments, display module 556 includes the up arrow button, as mentioned previously, which may be pressed to cause the numerical value of the concentration level associated with a high concentration alarm point to be displayed on screen 564. Buttons 566, 568, 572, LED 's 576, 578, and display screen 564 of each module 556 are some of the components included in the electric circuit of the respective module 556. In the illustrative example of FIG. 5, module 5.56 is configured to display oxygen concentration data.

When an alarm condition occurs in one of lines 16, the electric circuit of the associated display module 156, 556 operates to turn off “normal” LED 176, 576, to turn on the appropriate one of “low” pressure LED 178, “high” pressure LED 180, or “low” concentration LED 578 thereby providing a visual alarm of the corresponding alarm condition, and to activate the associated speaker thereby providing an audible alarm of an occurring alarm condition. Alarm silence button 168, 568 is pressed to turn off the audible alarm. In some embodiments, electric circuit 74 is programmed so that the audible alarm resounds within a predetermined period of time after being silenced, assuming the associated alarm condition is still occurring.

Test button 166, 566 is pressed to cause the electric circuit of the associated display module 156, 556 to run a self-diagnostic test routine. During the self-diagnostic test routine of any of display modules 156, 556, the associated electric circuit determines whether the respective display screen 164, 564, LED's 176, 178, 180, 576, 578, and the audible alarm are functioning properly. During this same self-diagnostic test routine, the electric circuit operates to display certain indicia on screen 164, 564 to prompt a user to press each of buttons 166, 168, 170, 172 or buttons 566, 568., 572, respectively, to assure the proper operation of buttons 166, 168, 170, 172, 566, 568, 572. If any portion of display module 156, 556 fails the self-diagnostic test, then an appropriate failure code is displayed on screen 164, 564. Of course, if screen 164, 564 fails the diagnostic test and is unable to display any information at all, this will be readily apparent since screen 164, 564 will be blank.

At any time during the operation of modules 156, 556 the electric circuit of each display module 156, 556 operates to display various error codes on the associated display 164, 564 if certain error conditions are detected. For example, in one embodiment, screen 164 displays “A 01” to indicate transducer pressure below sensor range, screen 164 displays “A 02” to indicate transducer pressure above sensor range, screen 164 displays “A 03” to indicate transducer communication time out, screen 164 displays “A 04” to indicate RAM error, screen 164 displays “A 05” to indicate ROM error, screen 164 displays “A 06” to indicate transducer status fault, screen 164 displays “A 07” to indicate incorrect transducer module connected to display module, screen 164 displays “A 08” to indicate display module programmed as vacuum but units are not inches of mercury or millimeters of mercury, screen 164 displays “A 09” to indicate display module programmed as pressure but units are not in psi or kPa, screen 164 displays “A 10” to indicate transducer programmed as invalid gas type, and screen 164 displays “A 11” to indicate transducer power short circuit detected. It will be appreciated that codes A 01 through A 11 are arbitrarily assigned and therefore, other error codes or text messages are within the scope of this disclosure.

Each display module 156, 556 includes a label 184, 584, respectively, or other suitable indicia that indicates the type of service for which the module 156, 556 has been programmed. For example, labels 184, 584 of the three modules 156, 556 included in the controller 50 of FIG. 5 indicate that a first of the three modules 156, 556 is programmed for use with the oxygen subsystem of gas system 12, a second of the three modules 156, 556 is programmed for use with the medical air subsystem of gas system 12, and a third of the three modules 156, 556 is programmed for use with the oxygen subsystem of gas system 12. In addition, controller 50 includes a set of labels 186 or other suitable indicia on panel 154 adjacent to respective modules 156, 556 to indicate a location in the healthcare facility associated with the pressure reading displayed by the respective module 156, 556. One example of information that may appear on label 186 is “ICU 2 EAST FLOOR 4.” Of course, there are essentially an unlimited number of possibilities for the text that may appear on labels 186 to indicate various locations throughout a healthcare facility.

Area alarm controller 50 includes a box 188 and a pair of hinge mechanisms 190 that couple panel 154 to box 188 for pivoting movement about a vertical axis 192 as shown in FIG. 6. Box 188 cooperates with panel 154 to provide a housing 154, 188 of controller 50. A locking device 194 is coupled to panel 154 and is operable to lock panel 154 in a closed position relative to box 188 and to unlock panel 154 for movement about axis 192 between the closed position and an opened position. Thus, panel 154 serves as a door of alarm controller 50.

Box 188 includes side panels 196, end panels 198, and a back panel 200. Panels 196, 198, 200 define an interior region 210 of box 188. Box 188 includes a front panel 212 that is parallel with back panel 200. Panel 212 includes a rectangular edge 214 that defines an opening 216 through which interior region 210 of box 188 is accessed when panel 154 is in the opened position. Panels 196, 198 extend perpendicularly between panels 200-212. Box 188 is configured so that panels 196, 198, 200 are receivable in an appropriately sized cavity or recess formed in a wall of a facility and so that portions of panel 212 extending perpendicularly outwardly from panels 114, 116 abut the wall of the facility to which alarm controller 50 is mounted.

Electric circuit 74 of area alarm controller 48 includes a power supply 218 that is mounted to back panel 200. Power supply 218 is the same or substantially similar to power supply 128 of master alarm controller 48. Thus, power supply 218 includes a transformer, a fuse holder, and an ON/OFF switch that function the same as transformer 130, fuse holder 132, and ON/OFF switch 134, respectively, of controller 48. Power supply 218 receives standard 110 Volt, 60 Hertz power from the healthcare facility and operates in a conventional manner to provide electrical power to the rest of circuit 74 via power lines 220.

Electric circuit 74 further includes a breakout board 222 mounted to back panel 200 and a main circuit board 224 mounted to panel 154 as shown in FIG. 6. Power lines 220 are coupled to breakout board 222 via suitable electrical connectors (not shown) well-known to those skilled in the art. Board 222 includes a connector bank 226 that provides a plurality of input ports for circuit 74. In the illustrative embodiment, connector bank 226 is configured with six input ports. In other embodiments, a different number of input ports are provided in circuit 74. Each input port provided by bank 226 includes three wire connection points, two of which are for respective wires of the twisted pair of the associated conductor 76 and one of which is for the shielding of the associated conductor 76. Panels 196, 198 each include one or more tabs 228 that are punched out to provide corresponding apertures in panels 196, 198 through which conductors 76 are routed to reach sensor modules 54.

Electric circuit 74 includes a ribbon cable 230 that electrically couples breakout board 222 to main circuit board 224. Connectors 232 at the opposite ends of ribbon cable 230 mate with corresponding connectors 234 of respective boards 222, 224. Input signals provided from sensor modules 54 on conductors 76 are communicated from board 222 to board 224 by ribbon cable 230. In addition, power is provided to board 224 from board 222 via ribbon cable 230. Electric circuit 74 further includes a set of ribbon cables 236 that electrically couple respective display modules 156, 556 to board 224. Connectors 238 are provided at the opposite ends of each ribbon cable 236. One of connectors 238 of each ribbon cable 236 mates with a corresponding connector 240 of the respective module 156, 556 and the other of connectors 238 of each ribbon cable mates with a corresponding connector 242 of board 224. In addition, power is provided to modules 156,556 from board 224 via respective ribbon cables 236.

Board 224 of circuit 74 carries a number of electrical components, including integrated circuit chips. Board 224 includes a communication port 244. A connector 246 at an end of conductor 78 couples to port 244. Conductor 78 is routed from port 244, through interior region 210 of box 188, through one of the apertures that are created in panels 196, 198 of box 188 when tabs 228 are punched out, and to one of network hubs 44. Thus, data is provided to circuit 74 from network 14 through port 244 and data is provided from circuit 74 to network 14 through port 244.

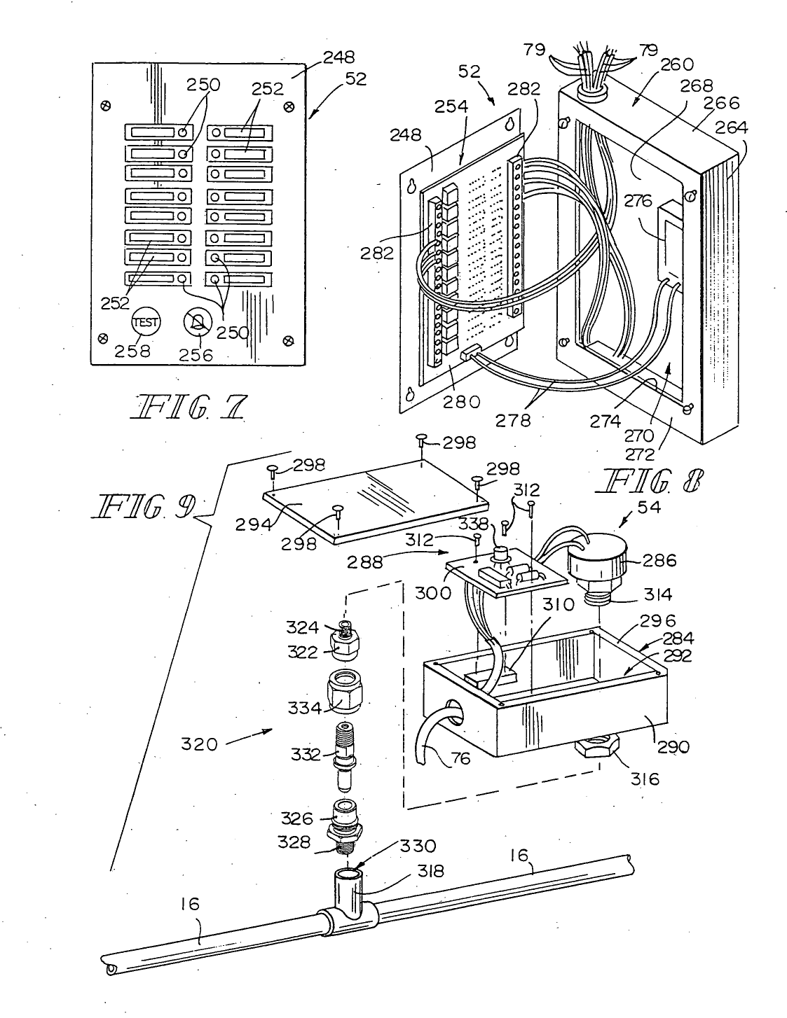

Local alarm annunciator 52 includes a panel 248 and a plurality of LED's 250 that are coupled to panel 248 as shown in FIG. 7. In the illustrative embodiment, annunciator 52 includes sixteen LED's 250 that are grouped into two side-by-side vertical columns of eight LED's 250. Other embodiments have different numbers and arrangements of LED's 250. Each LED 250 provides a visual indicator, such as by turning from green to red, of a corresponding alarm condition occurring in source equipment 18. Annunciator 52 also includes a plurality of labels 252 or other suitable indicia, each of which is positioned on panel 248 adjacent a respective LED 250 and each of which includes text identifying the alarm condition associated with the respective LED 250.

Annunciator 52 includes an electric circuit 254 having a speaker (not shown) or other sound-producing device that is activated to provide an audible alarm when input signals to annunciator 52 indicate an alarm condition is occurring in source equipment 18. Circuit 254 includes an alarm silence button 256 on panel 248 that, when pressed, silences the audible alarm. In some embodiments, LED's 250 flash red upon the occurrence of associated alarm conditions and LED's 250 will be steadily lit red when alarm silence button 256 is pressed. The occurrence of a new or additional alarm condition causes circuit 254 to resound the audible alarm. In addition, in some embodiments, circuit 254 causes the audible alarm to resound if a predetermined period of time passes after button 256 is pressed, assuming an alarm condition is still occurring after the predetermined period of time. Circuit 254 also includes a test button 258 that, when pressed, starts a self-diagnostic routine to check whether LED's 250 and the audible alarm are operating properly.

Annunciator 52 includes a box 260, shown in FIG. 8, to which panel 248 couples with suitable fasteners, such as screws 262. Box 260 cooperates with panel 248 to provide a housing 248, 260 of annunciator 52. Box 260 includes side panels 264, end panels 266, and a back panel 268. Panels 264, 266, 268 define an interior region 270 of box 260. Box 260 includes a front panel 272 that is parallel with back panel 268. Panel 272 includes a rectangular edge 274 that defines an opening through which interior region 270 of box 260 is accessed when panel 248 is decoupled from box 260. Panels 264, 266 extend perpendicularly between panels 268, 272.

Electric circuit 254 of annunciator 52 includes a power supply 276 that is mounted to back panel 268. Power supply 276 is the same as or substantially similar to power supplies 128, 218 of alarm controllers 48, 50. Thus, power supply 276 provides electrical power to the rest of circuit 254 via power lines 278. Electric circuit 254 further includes a circuit board 280 mounted to panel 248. Power lines 278 are coupled to board 280 via suitable electrical connectors (not shown). Board 280 includes a pair of connector banks 282 that provides a plurality of input ports for circuit 254. In the illustrative embodiment, each connector bank 282 is configured with eight input ports. In other embodiments, a different number of input ports are provided in circuit 254. Each input port of bank 282 includes two wire connection points, one for each wire of the twisted wire pairs that comprise conductors 79. One of panels 266 includes an opening through which conductors 79 are routed as shown in FIG. 8.

Board 280 of circuit 254 carries a number of electrical components, including integrated circuit chips. LED's 250 are included as part of circuit 254 and are positioned and arranged on board 280 so as to be visible through corresponding openings formed in panel 248 when board 280 is attached to the back of panel 254 as shown in FIG. 8. Circuit 254 includes output ports that, in some embodiments, are coupled to associated input ports of one or more master alarm controllers 48. That is, instead of having conductors extending from the switches of source equipment 18 to each master alarm controller 48 and to each local alarm annunciator 52, as is shown diagrammatically in FIG. 2, a first set of conductors may extend from the switches of source equipment 18 to annunciator 52 and then a second set of conductors may extend from annunciator 52 to one or more master alarm controllers 48.

If desired, two separate input signals that are coupled to annunciator 52 by respective conductors 79 to provide annunciator 52 with two separate alarms may be combined in circuit 254 into a single output signal that is then coupled to a single input port of one or more of master alarm controllers 48. For example, if one of the input signals to annunciator 52 indicates “high line pressure” and another of the input signals to annunciator 52 indicates “low line, pressure,” then these two input signals may be combined into a single output signal that is fed to one or more master alarm controllers 48 as an input signal that indicates “improper line pressure.” Pressure sensor module 54 includes a housing 284, a transducer 286 carried by housing 284, and an electric circuit 288 carried by housing 284 as shown in FIG. 9. Housing 284 includes a box 290 having an interior region 292 and a cover plate 294 that couples to a top edge 296 of box 290 with suitable coupling mechanisms, such as screws 298. Circuit 288 and transducer 286 are situated in interior region 292 of box 290 and are fastened in place with suitable fastening mechanisms. For example, in the illustrative embodiment, circuit 288 includes a circuit board 300 that mounts to rails 310 of box 290 with screws 312 and transducer 286 includes a threaded inlet 314 that extends through an opening (not shown) formed in box 290 into threaded engagement with a nut 316 such that a portion of box 290 is clamped between transducer 286 and nut 316.

A T-connector 318 is included in each line 16 at each of the points in lines 16 where the pressure is to be monitored by alarm system 10. A check valve assembly 320 extends between each T-connector 318 and the respective pressure sensor module 54 as shown in FIG. 9. Check valve assembly 320 includes an upper connector 322 having a threaded tip 324 that threads into a bore (not shown) of threaded inlet 314 of transducer 286. Check valve assembly 320 also includes a lower connector 326 having a threaded tip 328 that threads into a bore 330 of T-connector 318. Check valve assembly 320 further includes a check valve unit 332 and a nut 334 that are interposed between connectors 322, 326.

Check valve assembly 320 operates to pneumatically couple pressure sensor module 54 to line 16 so that transducer 286 is exposed to the pressure in line 16 when pressure sensor module 54 is coupled to assembly 320. When module 54 is decoupled from assembly 320, check valve unit 332 closes so that, in the case of services having pressures above atmospheric pressure, the associated service in line 16 does riot leak to atmosphere and so that, in the case of services having pressures below atmospheric pressure, air from the atmosphere does not enter into line 16. In preferred embodiments, check valve assembly 320 is constructed in accordance with the Diameter Index Safety System (BISS) protocol, which specifies the diameters that pneumatic connectors should have when being used with different types of services.

Transducer 286 operates in a conventional manner to produce an analog pressure signal that indicates the pressure to which transducer 286 is exposed. The analog pressure signal is communicated to circuit 288 on conductors 336. Circuit 288 is a microprocessor-based circuit that processes the pressure signal, such as by performing analog-to-digital conversion, and that transmits digital pressure data on the respective conductor 76 to the associated area alarm controller 50. Circuit 288 also transmits a host of other data to the associated alarm controller 50 in addition to transmitting data indicative of the pressure in the respective line 16.

Other types of data transmitted by circuit 288 to alarm controller 50 include, for example, serial number data, gas type data, software data, characteristic data, and status data. Serial number data indicates the serial number of the pressure sensor module 54 transmitting the data. Gas type data indicates the type of service for which pressure sensor module 54 is configured. Software data indicates the software revision number of software with which circuit 288 is programmed. Characteristic data indicates the characteristic, such as pressure or flow rate, being monitored by pressure sensor module 54. Status data indicates whether pressure sensor module 54 is operating properly or whether a fault condition has occurred. If a fault condition has occurred, then circuit 288 also transmits fault data which indicates the type of failure that occurred. Some of the fault data received by controller 50 causes the appropriate one of error codes A 01-A 11 to be displayed on screen 164 of the display module 156 associated with the pressure sensor module 54 sending the fault data.

Circuit 288 includes one or more LED's 338 that provides a visual indicator of whether pressure sensor module 54 is operating properly or whether a fault condition has occurred. If pressure sensor module 54 is operating properly, then circuit 288 causes LED 338 to flash or strobe with a low frequency. If a fault condition occurs in pressure sensor module 54, then circuit 288 causes LED 338 to flash or strobe with a high frequency. Housing 284 of sensor module 54 is made of a transparent or semi-transparent material, such as, for example, a smoky plexiglass material, which enables observers to see the light that emanates from LED 338. Thus, LED 338 provides a visual “heartbeat” signal that an observer is able to see to quickly determine the status of pressure sensor module 54.

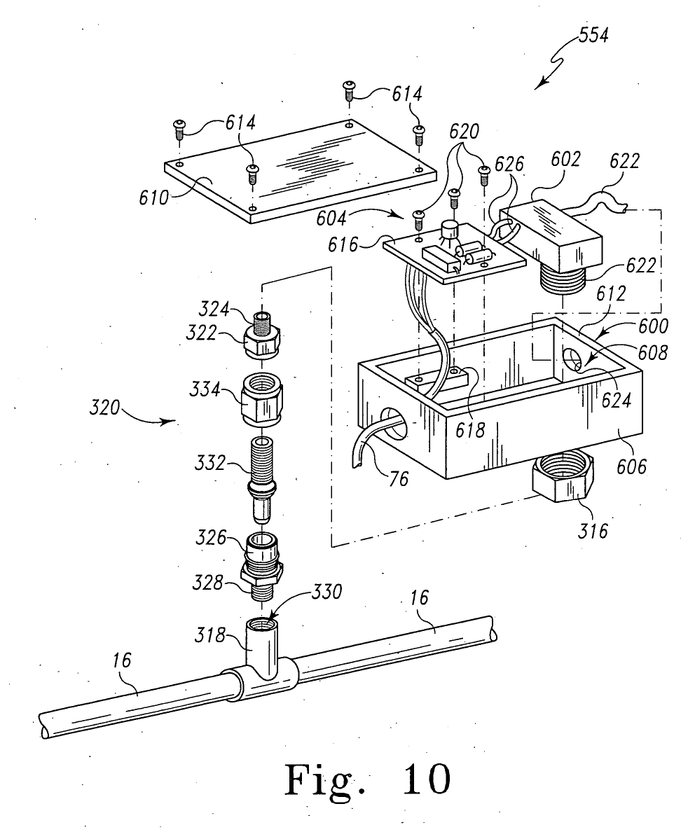

In one illustrative embodiment, gas sensor module 554 includes a housing 600, a ceramic oxygen sensor 602 carried by housing 600, and an electrical circuit 604 carried by housing 600 as shown in FIG. 10. Thus, in the illustrative example of FIG. 10, gas sensor module 554 is configured for measuring oxygen concentration. Of course, if the oxygen concentration is within predetermined limits, then gas sensor module 554 may provide a signal to an associated area alarm controller 50 that the proper type of gas, in this case oxygen, is extant in the associated gas line 16.

Housing 600 includes a box 606 having an interior region 608, a cover plate 610 that couples to a top edge 612 of box 606 with suitable coupling mechanisms, such as screws 614. Box 606 includes an exhaust opening 624 that receives or is otherwise coupled to a first end of an exhaust tube 622. A second end of exhaust tube 622 is coupled to sensor 602. Circuit 604 and sensor 602 are situated in interior region 608 of box 606 and are fastened in place with suitable fastening mechanisms. For example, in the illustrative embodiment, circuit 604 includes a circuit board 616 that mounts to rails 618 of box 606 with screws 620. Sensor 602 includes a threaded inlet 622 that extends through an opening (not shown) formed in box 606 into threaded engagement with nut 316 such that a portion of box 606 is clamped between ceramic oxygen sensor 602 and nut 316.

Sensor 602 is exposed to a sample flow of gas from line 16. The sample flow of gas flows through sensor 602 and bleeds to the ambient atmosphere through exhaust tube 622. Based on the oxygen concentration of the sample flow of gas through sensor 602, a signal indicative of the oxygen concentration of the gas extant in line 16 is transmitted to circuit 604 by way of conductors 626. In one embodiment, sensor 602 is of the type having a ceramic zirconia electrolyte material that is exposed to the gas to produce the oxygen concentration signal, such as those manufactured by Fujikura Ltd., of Tokyo, Japan.

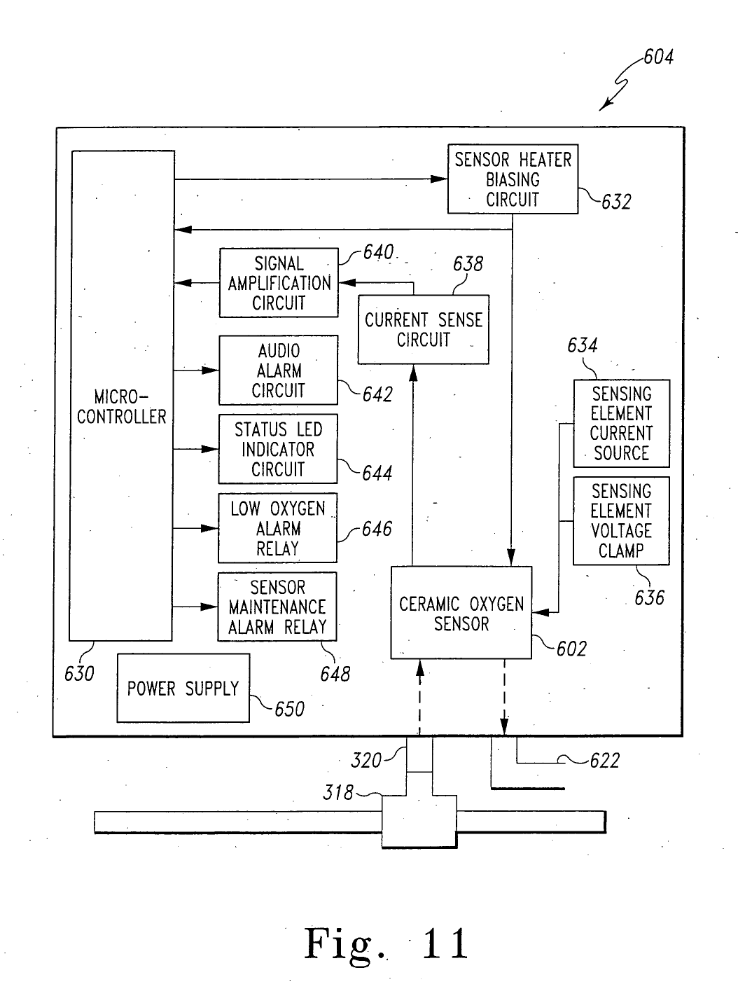

Circuit 604 includes a microcontroller 630 and a power supply 650, as shown diagrammatically in FIG. 11. Power supply 650 provides a plurality of voltages to circuit 604, including a supply voltage to microcontroller 630. Microcontroller 630 controls a sensor heater biasing circuit 632 coupled to sensor 602. Biasing circuit 632 applies an appropriate voltage, which in some embodiments is dictated by the make and model of the sensor, to the built-in heater of sensor 602. A current is applied to sensor 602 by a sensing element current source 634. The current flow through sensor 602 varies as a function of the oxygen concentration of the gas flow being monitored by sensor 602. In particular, the current through sensor 602 increases as the concentration of oxygen of the gas flow being monitored by sensor 602 increases. Current source 634 includes a current protection circuit (not shown) that limits the maximum current flowing through sensor 602. Similarly, a sensing element voltage clamp 636 limits the maximum voltage applied to sensor 602 to a predetermined voltage. For example, in one embodiment, as the oxygen concentration reaches 95%, the current protection circuit limits the current applied to sensor 602, resulting in a bias voltage less than the predetermined voltage limit. When the oxygen concentration falls below 95%, voltage clamp 636 limits the voltage applied to sensor 602.

The current flowing through sensor 602 is applied to an input of a current sense circuit 638. An output of sense circuit 638 is coupled to a signal amplification circuit 640. An amplified signal produced by amplification circuit 640 is coupled to an input of microcontroller 630. Microcontroller 630 monitors the oxygen concentration flowing through line 16 by processing the amplified signal, which correlates to the oxygen concentration sensed by sensor 602, such as by performing analog-to-digital conversion and comparing a resultant digital value to one or more predetermined threshold values stored in memory.

If the oxygen concentration in line 16 falls below a predetermined level, for example 95%, microcontroller 630 will produce an output signal to an audio alarm circuit 642 and to a status LED indicator circuit 644, both of which are coupled to outputs of microcontroller 630. Alarm circuit 642 provides an audio indication of low oxygen concentration, while indicator circuit 644 provides a visual indication of low oxygen concentration. Additionally, microcontroller 630 will produce an output signal to a low oxygen alarm relay 646 when a low oxygen concentration in line 16 is sensed by sensor 602. Microcontroller 630 also monitors the plurality of circuits and sensors comprising circuit 604. If an error is detected in one or more of these circuits or sensors, microcontroller 630 will produce a signal to a sensor maintenance alarm relay 648. Relay 648 provides notification that concentration sensor module 554 may need to be serviced. Various data from circuit 604, including the status of relays 646, 648, is communicated to the associated alarm controller 50 via conductors 76. In some embodiments, serial data similar to that mentioned above in connection with circuit 300 is transmitted by circuit 602 to the associated alarm controller 50 via conductors 76.

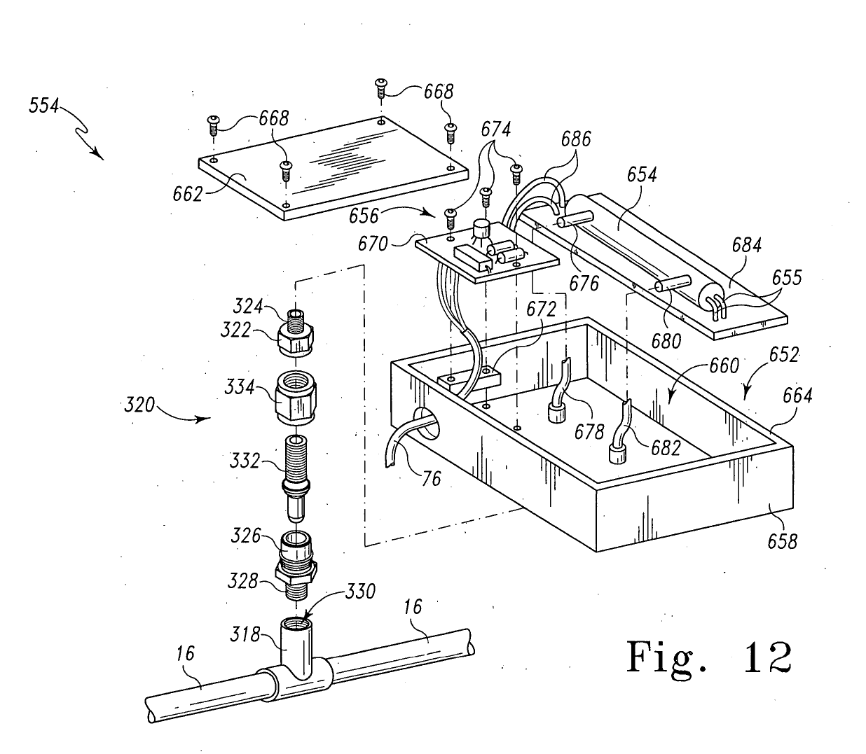

In another illustrative embodiment, oxygen concentration sensor module 554 includes a housing 652, an ultrasonic oxygen sensor 654 carried by housing 652, and an electrical circuit 656 carried by housing 600 as shown in FIG. 12. Housing 652 includes a box 658 having an interior region 660, a cover plate 662 that couples to a top edge 664 of box 658 with suitable coupling mechanisms, such as screws 668. Sensor 654 includes a gas intake port 676 coupled to an intake tube 678 and a gas exhaust port 680 coupled to an exhaust tube 682. Intake tube 678 is coupled to the threaded tip 324 of the check valve assembly 320 through an opening (not shown) in box 658. Exhaust tube 682 is coupled to an opening (not shown) in box 658. Circuit 656 is situated in interior region 660 of box 658 and is fastened in place with suitable fastening mechanisms. For example, in the illustrative embodiment, circuit 656 includes a circuit board 670 that mounts to rails 672 of box 658 with screws 674. Sensor 654 is mounted on a circuit board 684 and is electrically coupled to other circuitry on board 684 by sensor conductors 655. Circuit board 684 is fastened in place within the interior region 660 of box 568 with suitable fastening mechanisms, for example screws, clips, or bolts.

Sensor 654 is exposed to a sample flow of gas from line 16. The sample flow of gas enters sensor 654 through port 676 and bleeds to the ambient atmosphere through port 680. Based on the oxygen concentration of the sample flow of gas within sensor 654, a signal indicative of the oxygen concentration of the gas extant in line 16 is transmitted to circuit 656 by way of conductors 686. In one embodiment, sensor 654 is of the type that senses a concentration of oxygen based on an amount of time that ultrasonic waves propagate through a cavity containing a sample of gas, such as those which are manufactured by DigiFLO, Inc., of Bellevue, Wash and which are shown and described in U.S. Pat. No. 5,627,323 which is hereby incorporated by reference herein. Sensors similar to sensor 654 are able to sense gas flow in addition to gas concentration as explained in U.S. Pat. No. 5,627,323. In addition, these types of sensors may be configured to sense flow and concentration of any of a number of different gases.

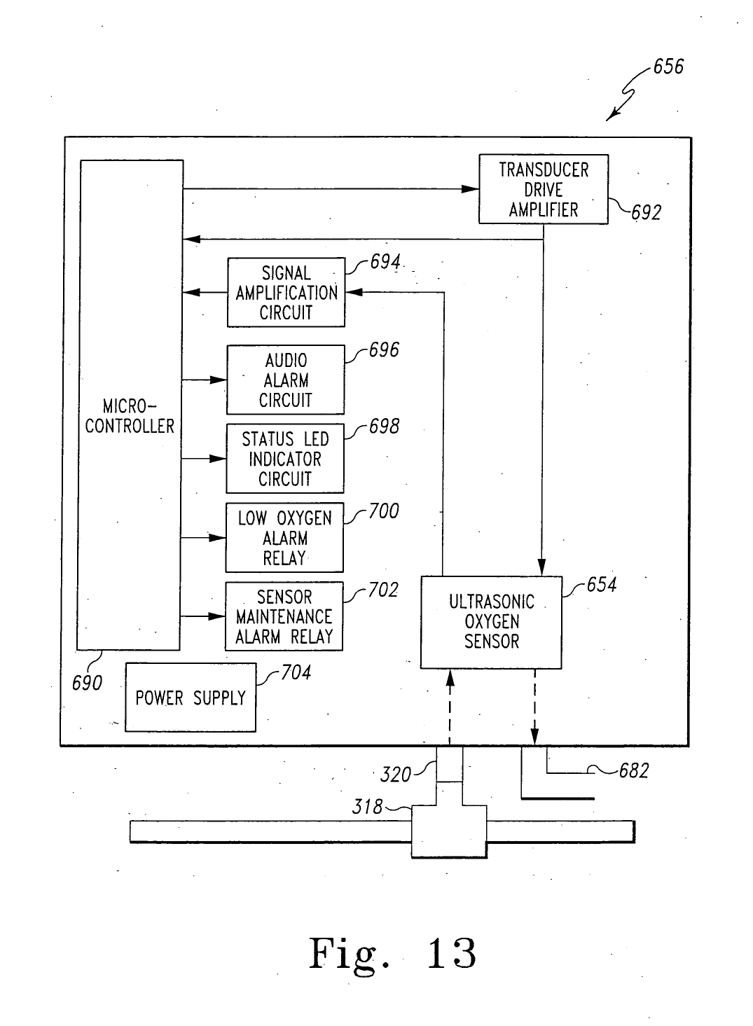

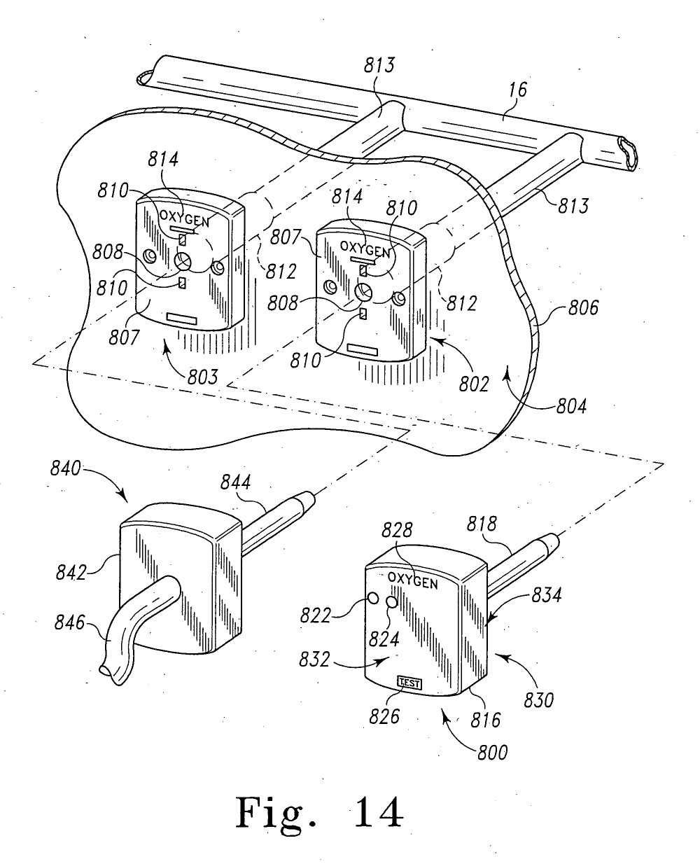

Circuit 656 includes a microcontroller 690 and a power supply 704, as shown diagrammatically in FIG. 13. Power supply 704 provides a plurality of voltages to circuit 656, including a supply voltage to microcontroller 690. Microcontroller 690 controls a transducer drive amplifier 692 coupled to sensor 654. Sensor 654 produces a signal indicative of the oxygen concentration of the gas flow through sensor 654. The signal produced by sensor 654 is amplified by a signal amplification circuit 694. An amplified signal-produced by amplification circuit 694 is coupled to an input of microcontroller 690. Microcontroller 690 monitors the oxygen concentration flowing through line 16 by processing the amplified digital signal, which correlates to the oxygen concentration sensed by sensor 654, such as by performing analog-to-digital conversion and comparing a resultant digital value to one or more predetermined values stored in memory.

If the oxygen concentration in line 16 falls below a predetermined level, for example 95%, microcontroller 690 will produce an output signal to an audio alarm circuit 696 and to a status LED indicator circuit 698, both of which are coupled to outputs of microcontroller 690. Alarm circuit 696 provides an audio indication of low oxygen concentration, while indicator circuit 698 provides a visual indication of low oxygen concentration. Additionally, microcontroller 690 will produce an output signal to a low oxygen alarm relay 700 when a low oxygen concentration in line 16 is sensed by sensor 656. Microcontroller 690 also monitors the plurality of circuits and sensors comprising circuit 656. If an error is detected in one or more of these circuits or sensors, microcontroller 690 will produce a signal to a sensor maintenance alarm relay 702. Relay 702 provides notification that concentration sensor module 554 may need serviced. Various data from circuit 656, including the status of relays 700, 702, is communicated to the associated alarm controller 50 via conductors 76. In some embodiments, serial data similar to that mentioned above in connection with circuit 300 is transmitted by circuit 656 to the associated alarm controller 50 via conductors 76.

The gas sensor modules 554 shown in FIGS. 10-13 are coupled to respective lines 16, which illustratively contain a gas of which the oxygen concentration is to be monitored, by T-connector 318 and by check valve assembly 320 in a similar fashion as pressure sensor module 54 is coupled to lines 16, as previously described in connection with FIG. 9. Check valve assembly 320 operates to pneumatically couple sensor modules 554 to lines 16 so that sensors 602, 654 are exposed to the gas in lines 16 when sensors 602, 654 are coupled to respective assembly 320. When modules 554 are decoupled from respective assemblies 320, the corresponding check valve units 332 close so that, in the case of services having pressures above atmospheric pressure, the associated gases in line 16 do not leak to atmosphere and so that, in the case of services having pressures below atmospheric pressure, air from the atmosphere does not enter into lines 16.

Each of alarm controllers 48, 50, each display module 156, 556, each pressure sensor module 54, and each gas sensor module 554 includes its own microcontroller or microprocessor as mentioned above. The microcontrollers of one or more of these devices is configured to monitor the various electrical connections to the respective devices, 48, 50, 156, 556, 54, 554. If an electrical connection is lost or broken, a fault condition will be detected by the one or more microcontrollers that are configured to detect such conditions.

Additional details of medical gas alarm system 10 can be found in U.S. patent application Ser. No. 09/933,502 which is incorporated by reference herein.

According to this disclosure, a self-contained gas sensor module 800, shown in FIG. 14, is provided for use in a healthcare facility. Illustratively, module 800 is configured to determine that oxygen is the proper type of gas extant in the line 16 to which module 800 is coupled. Conventionally, healthcare facilities include a plurality of oxygen gas service outlets, such as illustrative outlets 802, 803, mounted by suitable mechanisms, such as screws, to a structure of the healthcare facility, for example, a surface 804 of a healthcare facility wall 806, as shown in FIG. 14. Outlets similar to outlets 802, 803 are sometimes mounted to walls of headwall units, service columns, or to other structures. Module 800 is configured for coupling to either of outlets 802, 803.

Service outlets 802, 803 each include a face plate 807 in which is formed an outlet port 808 and a plurality of key-receiving apertures 810. Outlets 802, 803 each include a service line coupler 812 that pneumatically couples ports 808 to conduits or pipes 813 which, in turn, are in gas-flow communication with line 16. Port 808 and apertures 810 are fashioned to allow healthcare facility equipment requiring a flow of oxygen gas to be coupled to service outlet 802, 803. Apertures 810 are located on face plate 807 so that only structures having a plurality of tabs or keys that correctly mate with key-receiving apertures 810 may be coupled to outlets 802, 803. Equipment that does not include keys at the proper locations will not couple successfully to service outlets 802, 803.

Line couplers 812 couple the service outlets 802, 803 to the respective gas line 16 which is positioned behind wall 806 as previously mentioned. Each line coupler 812 includes a valve assembly (not shown) that stops the flow of gas from line 16 when equipment is not coupled to service outlet 802, 803 and provides a flow of gas from line 16 when equipment is successfully coupled to service outlet 802, 803. Additionally, service outlet 802,803 may include a label 808 identifying the service supplied by service outlets 802, 803, for example, label 808 may read “OXYGEN.”

In one embodiment, sensor module 800, shown in FIG. 14, includes a gas intake barrel 818 and a housing 816, within which is housed oxygen concentration sensing circuitry, for example, one of electrical circuits 604, 656. Module 800 includes a test button 826, a normal condition LED 822, an alarm condition LED 824, and a label 828 on a first side 832 of housing 816. However, button 826, LED 822,

LED 824, and label 828 may be located on other sides of housing 816, for example, on side 834. Housing 816 also includes a plurality of keys (not shown) coupled to a second side 830 of housing 816. The keys on second side 830 of housing 816 are configured and arranged to allow the coupling of module 800 to either of outlets 802, 803. A barrel 818 protrudes from second side 830 of housing 816 and extends through port 808 to interface with the valve assembly in coupler 812 when module 800 is coupled to outlet 802.

Barrel 818 provides a sample flow of gas from service outlet 802 to the electric circuit contained within housing 816 when sensor module 800 is coupled to service outlet 802. The electrical circuit of module 800 monitors the oxygen concentration of the sample flow in the manner described above in connection with circuits 604, 656. The circuitry of module 800 provides a visible indication of the oxygen concentration of the sample flow by lighting the normal condition LED 822 when the concentration is above a predetermined concentration, for example, 95% concentration. The circuitry of module 800 dims LED 822 and lights alarm condition LED 824 if the oxygen concentration sensed in the sample flow is below the predetermined level. Alternatively, a single LED is provided in module 800 and either turns from an OFF state to an ON state when an alarm condition occurs or changes color, such as changing from green, which indicates proper gas type or concentration, to red, which indicates improper gas type or concentration. In an alternative embodiment, a display screen is coupled to housing 816 and displays the oxygen concentration. Additionally, in some embodiments, an audible alarm is enclosed in housing 816 and provides an audible warning during alarm conditions.

Pressing test button 826 causes the circuitry of module 800 to perform a self-diagnostic test.

When sensor module 800 is coupled to service outlet 802, the circuitry of sensor module 800 monitors the oxygen concentration of the gas in line 16 being delivered to surrounding service outlets 803 that are coupled to line 16 either upstream of or downstream from outlet 802. For example, healthcare facility equipment having a connector 840, including a main body 842, a gas intake barrel 844, a gas hose 846, and a plurality of keys (not shown), may be coupled to service outlet 803. The oxygen concentration of the gas delivered to connector 840, which is coupled to outlet 803, is monitored by sensor module 800, which is coupled to service outlet 802, because outlets 802, 803 are coupled to the same line 16. Although illustrative outlets 802, 803 are shown to be in close proximity to each other, service outlets 802, 803 may be separated by a greater distance. For example, service outlet 802 may be positioned in a first room of the healthcare facility and service outlet 803 may be positioned in a second room of the healthcare facility. In addition, service outlets (not shown) associated with other medical gas services, such as nitrogen or vacuum, for example; may be coupled to wall 806 between outlets 802, 803.

In another embodiment, a sensor module 900, shown in FIG. 15, includes a housing 850, within which is housed oxygen concentration sensing circuitry such as, for example, one of electrical circuits 604, 656. Module 900 also includes a test button 854, a normal condition LED 856, an alarm condition LED 858, a label 860, a plurality of key-receiving apertures 868, and an outlet port 870 on a first side 862 of housing 850. However, button 854, LED 856, LED 858, and label 860 may be located on other sides of housing 850, for example, on side 866. Housing 850 also includes a plurality of keys (not shown) coupled to a second side 864 of housing 850. The keys on second side 864 of housing 850 are configured and arranged to allow the coupling of module 900 to an oxygen gas service outlet, for example, service outlet 802. A barrel 818 protrudes from housing 850 on second side 864 of housing 850 and extends through port 808 when module 900 is coupled to a service outlet, such as illustrative outlet 802.

When sensor module 900 is coupled to service outlet 802, barrel 852 interfaces with the valve assembly in coupler 812. The interfacing of barrel 852 and the valve assembly of coupler 812 permits gas to flow from the respective gas line 16 through the valve assembly of coupler 812 to module 900. Port 870 of module 900 is fashioned similar to port 808 of service outlet 802 and allows equipment requiring a flow of oxygen gas to be coupled to module 900. A valve assembly (not shown) included in port 870 of module 900 restricts the flow of gas from port 870 when equipment is not coupled to module 900 and permits a feed-through flow of gas through port 870 when equipment is successfully coupled to module 900. Apertures 868 are located on first side 862 of housing 850 so that only structures having a plurality of tabs or keys that correctly mate with key-receiving apertures 868 may be coupled to module 900. Equipment that does not include keys at the proper locations will not couple successfully to module 900.

When sensor module 900 is coupled to service outlet 802, a sample flow of gas is diverted by an appropriate flow diverter from the main flow of gas through module 900. The circuitry contained within housing 850 monitors the oxygen concentration of the sample flow in the manner described above in connection with circuits 604, 656. The circuitry of module 900 provides a visible indication of the oxygen concentration of the sample flow by lighting the normal condition LED 856 when the concentration is above a predetermined concentration, for example, 95% concentration. The circuitry of module 900 dims LED 856 and lights alarm condition LED 858 if the oxygen concentration sensed in the sample flow is below the predetermined concentration. Alternatively, a single LED is provided in module 900 and either turns from an OFF state to an ON state when an alarm condition occurs or changes color, such as changing from green, which indicates proper gas type or concentration, to red, which indicates improper gas type or concentration. In an alternative embodiment, a display screen is coupled to housing 850 and displays the oxygen concentration. Additionally, in some embodiments, an audible alarm is enclosed in housing 850 and provides an audible warning during alarm conditions.

Pressing test button 854 causes the circuitry of module 900 to perform a self-diagnostic test.

The coupling of sensor module 900 to service outlet 802 allows sensor module 900 to monitor the oxygen concentration of the gas flow being delivered to equipment successfully coupled to sensor module 900. For example, equipment having connector 840, including a main body 842, a gas intake barrel 844, a gas hose 846, and a plurality of keys 820, may be coupled to module 900. Barrel 844 of connector 840 interfaces with the valve assembly included in port 870 of housing 850. The interfacing of barrel 844 and the valve assembly of port 870 permits a flow of gas from module 900 to connector 840. The oxygen concentration of the gas delivered to connector 840, which is coupled to module 900, is monitored by sensor module 900, which is coupled to service outlet 802. In some embodiments, illustrative sensor module 900 is configured to substantially continuously monitor the gas contained in line 16 even when no other equipment is coupled to module 900 and, thereby, provide oxygen concentration monitoring of other service outlets that are coupled to the same line 16 as outlet 802 and module 900, but that are spaced from outlet 802.

In a further embodiment, a sensor module 1000 is mounted by suitable mechanisms, such as screws, to a structure of the healthcare facility, for example surface 804 of wall 806, as shown in FIG. 16. Illustratively, sensor module 1000 includes a service line coupler 874 and a housing 872, within which is housed oxygen concentration sensing circuitry, for example, electrical circuit 604, 656. Module 1000 also includes a normal condition LED 878, an alarm condition LED 880, a label 882, a plurality of key-receiving apertures 890, and an outlet port 892 on a first side 884 of housing 872. Additionally, module 1000 includes a test button 876 on a second side 886 of housing 872. However, button 876, LED 878, LED 880, and label 882 may be located on other sides of housing 872, for example, on side 888. Line coupler 874 couples module 1000 to the respective gas line 16 which is positioned behind wall 806. Line coupler 872 includes a valve assembly (not shown) that stops the flow of gas from line 16 when healthcare facility equipment is not coupled to module 1000 and provides a flow of gas from line 16 when equipment is successfully coupled to module 1000.

Port 892 of module 1000 is fashioned similar to port 808 of service outlet 802 and allows equipment requiring a flow of oxygen gas to be coupled to module 1000. A valve assembly (not shown) included in port 892 of module 1000 restricts the flow of gas from port 892 when equipment is not coupled to module 1000 and permits a flow of gas through port 892 when equipment is successfully coupled to module 1000. Apertures 890 are located on first side 884 of housing 872 so that only structures having a plurality of tabs or keys that correctly mate with key-receiving apertures 890 may be coupled to module 1000. Equipment that does not include keys at the proper locations will not couple successfully to module 1000.

Sensor module 1000 monitors the oxygen concentration of the gas flow being delivered to equipment successfully coupled to module 1000. For example, healthcare facility equipment having connector 840, including main body 842, gas intake barrel 844, gas hose 846, and plurality of keys 820, may be coupled to module 1000. When connector 840 is coupled to sensor module 1000, a sample flow of gas is diverted by an appropriate diverter from the main flow of gas being delivered to connector 840. The circuitry within housing 872 monitors the oxygen concentration of the sample flow in a manner described above in connection with circuits 604, 656. The circuitry of module 1000 provides a visible indication of the oxygen concentration of the sample flow by lighting the normal condition LED 878 when the concentration is above a predetermined concentration, for example, 95% concentration. The circuitry of module 1000 dims LED 878 and lights alarm condition LED 880 if the oxygen concentration sensed in the sample flow is below the predetermined concentration. Alternatively, a single LED is provided in module 1000 and either turns from an OFF state to an ON state when an alarm condition occurs or changes color, such as changing from green, which indicates proper gas type or concentration, to red, which indicates improper gas type or concentration. In an alternative embodiment, a display screen is coupled to housing 872 and displays the oxygen concentration. Additionally, in some embodiments, an audible alarm is enclosed in housing 872 and provides an audible warning during alarm conditions. Pressing test button 854 causes the circuitry of module 1000 to perform a self-diagnostic test.

In some embodiments, sensor module 1000 is configured to substantially continuously monitor the gas contained in line 16 even when no other equipment is coupled to module 1000 and, thereby, provide oxygen concentration monitoring or gas type monitoring of other service outlets that are coupled to the same line 16 as module 1000, but that are spaced from module 1000. In such an embodiment providing substantially continuous gas monitoring, an appropriate gas flow diverter is provided to divert a small sample of gas from line 16 around the valve assembly of line coupler 874. In further embodiments, illustrative sensor module 1000 may be coupled to one of alarm controllers 50 of gas alarm system 10 by an electrical line 894 or may be coupled directly to one of the hubs of the computer network by electrical line 894. Power is provided to illustrative module 1000 via conductors in line 894 and data is transmitted to and/or from module 1000 via conductors in line 894.

In some embodiments, oxygen concentration sensor modules 800, 900, 1000 receive power from a battery supply system enclosed in respective housings 816, 850, 872. If sensor modules 800, 900, 1000 are powered by a battery supply system, housings 816, 850, 872 may include a “low” power LED that is illuminated by a voltage monitoring circuit included in housings 816, 850, 872 when the voltage of the battery supply system falls below a predetermined value. In other embodiments, sensor modules 800, 900, 1000 receive power through a power cord configured to couple to a nearby 120 volt power outlet. If sensor modules 800, 900, 1000 are powered by a 120 volt service outlet, housings 816, 850, 872 include a transformer circuit that adapts the 120 volt power to appropriate voltages required by other circuitry contained in housings 816, 850, 872.

Referring now to FIGS. 17-23, use of a main gas alarm module 1100 and one or more remote gas alarm modules 1120 in a medical gas system 1110 are shown. In the illustrative example, the main gas alarm module 1100 is coupled pneumatically to a main gas outlet line 1116 adjacent a main gas supply 1118 and communicates electrically with the at least one remote gas alarm module 1120 as shown diagrammatically in FIG. 17. The main gas supply 1118 includes a number of high pressure supply tanks 1102, which may include gases or liquid of the same type or of different types. Each of tanks 1102 is coupled to a manifold 1104 by an associated conduit 1106.

Manifold 1104 has suitable passageways, valves, pressure regulators, and so forth, as is known by those skilled in the art, that cooperate to control which of tanks 1102 is coupled pneumatically to main gas outlet line 1116. If any of tanks 1102 contain liquid, such as liquid oxygen for example, the liquid changes to gas due to pressure changes between tanks 1102 and lines 1106 as is known in the art. The components of manifold may mix the gases from the various tanks 1102, if a gas mixture is to be provided to main gas outlet line 1116. Alternatively, gas mixtures may be contained in tanks 1102 prior to delivery to the remainder of system 1110. The pressure in tanks 1102 is usually quite high and thus, manifold 1104 operates to reduce the gas pressure so that the pressure in line 1116 is within an acceptable range for delivery to patients and/or medical equipment. Line 1116 delivers gas from manifold 1104 to the hospital piped network 1108 which includes various pipes (not shown) that lead to service outlets (not shown) located throughout an associated medical facility.

Main gas alarm module 11 00 (sometimes referred to herein as “gas sensor module 1100” or “sensor module 1100”) senses the gas content (i.e., gas type) and/or gas flow, as it exits the main gas supply 1118 and before the gas reaches service outlets of the hospital piped network 1108. Thus, sensor module 1100 senses whether the proper gas is extant in line 1116 and also may sense that gas is flowing in line 1116 within a predetermined flow rate. If sensor module 1100 senses an improper gas, which may occur if one or more of tanks 1102 contains a type of gas other than the type of gas designated for line 1116 and the associated piped network 1108, or if sensor module 1100 senses an improper flow rate, then sensor module 1100 will so indicate with an audible and/or visual alarm.

Gas sensor module 1100 is coupled electrically with one or more remote alarms 1120 as previously mentioned. Alarm conditions sensed by sensor module 1100 are communicated to the one or more remote alarm modules 1120 so that audible and/or visual alarms may be activated at the various remote locations throughout the healthcare facility where remote alarm modules 1120 are located. Thus, caregivers in the vicinity of each of the remote alarm modules 1120 throughout the healthcare facility are alerted to the alarm conditions sensed by sensor module 1100 adjacent the main gas supply 1118 when the alarms of modules 1120 are activated. Thus, the caregivers can take immediate corrective actions at the points of care, such as disconnecting patients and/or medical equipment from medical gas system 1110, when the alarms of the modules 1120 are activated.

In the illustrative example, a Y-connector 1112 having DISS fittings 1114 at the ends thereof connects a tap 1122 from line 1116 both to sensor module 1100 and to a pressure gage 1124. The gas supplies in many medical gas systems have pressure gages coupled to the main gas outlet line exiting the associated manifold so that the pressure in the main gas outlet line can be read directly. To convert such a system to one with sensor module 1100, the gage is removed from the associated DISS fitting and then the inlet portion of Y-connector 1112 is coupled to the DISS fitting that previously have the gage coupled thereto. Then sensor module 1100 is coupled to one of the outlet portions of Y-connector 1112 and the gage is coupled to the other of the outlet portions of Y-connector 1112. Of course, gas sensor module 1100 may be coupled to line 1116 or to other lines in the hospital piped network 1108 in any number of ways in lieu of using Y-connector 1112 if desired.

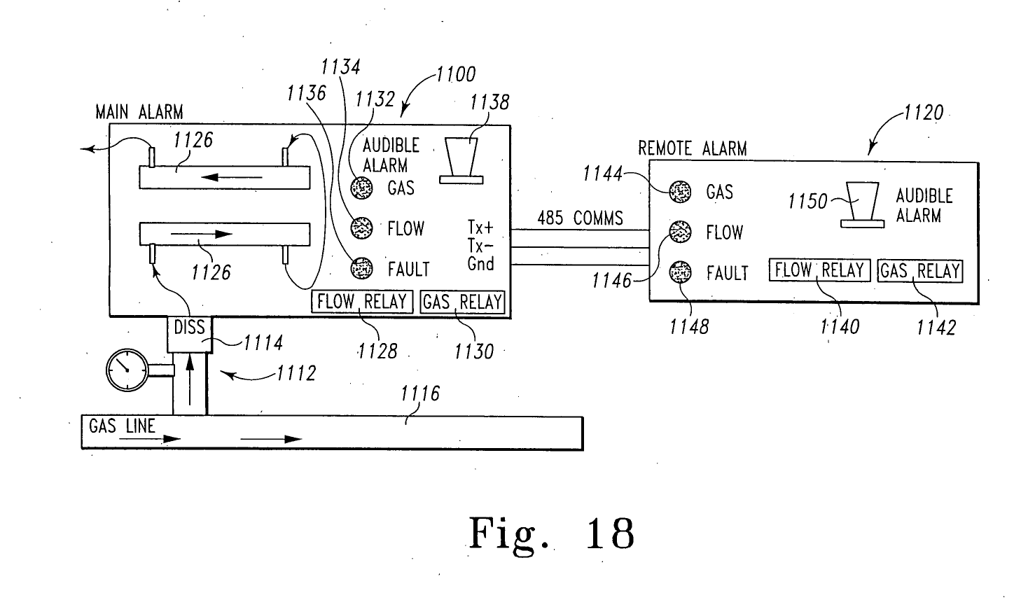

As shown diagrammatically in FIG. 18, main gas alarm module 1100 has a pair of gas sensors 1126, which in the illustrative embodiment are ultrasonic gas sensors that are each capable of sensing gas concentration and gas flow. Thus, gas sensors 1126 are of the type mentioned above as being manufactured by DigiFLO, Inc., of Bellevue, Wash. and which are shown and described in U.S. Pat. No. 5,627,323 which is incorporated by reference herein. Providing sensor module 1100 with two of gas sensors 1126, which are coupled together in series so that the outlet of a first of gas sensors 1126 is coupled to the inlet of a second of gas sensors 1126, allows for redundant gas monitoring. It is within the scope of this disclosure for module 1100 to have more or less than two gas sensors 1126.

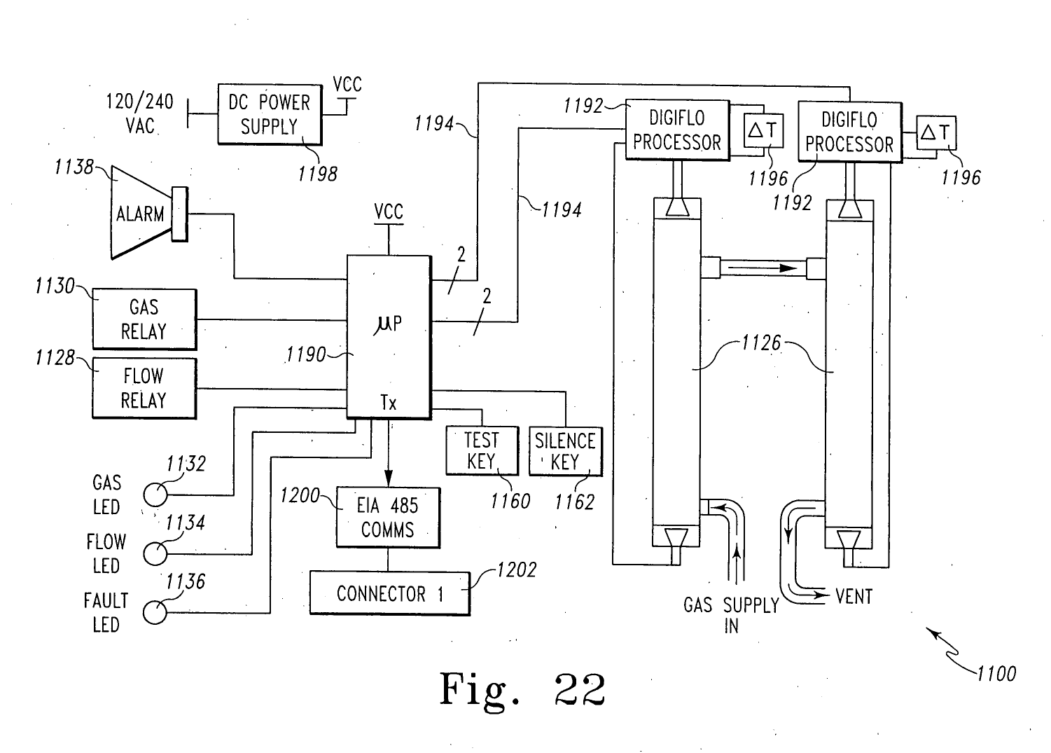

Sensor module 1100 has a flow relay 1128 and a gas relay 1130 as shown diagrammatically in FIG. 18. Module 1100 has circuitry, discussed in further detail below in connection with FIG. 22, that normally closes relays 1128, 1130 when the proper gas type and proper gas flow are sensed. If an improper gas type is sensed, then gas relay 1130 is opened. Similarly, if an improper gas flow is sensed, then flow relay 1128 is opened. Thus, the circuitry of sensor module 1100 is considered to be a supervised circuit in that relays 1128, 1130 are normally closed and are opened when an alarm condition is sensed. In alternative embodiments, module 1100 may be configured with a non-supervised circuit in which the relays are normally opened and are closed when an alarm condition is sensed.

Sensor module 1100 has a visual alarm comprising a gas LED 1132, a flow LED 1134, and a fault or alarm LED 1136 as shown in FIGS. 18, 19 and 22. In some embodiments, each of LED's 1132, 1134, 1136 are configured to shine with different colors, such as green, amber (i.e. yellow), or red, depending upon the signal applied thereto. In addition, sensor module 1100 has an audible alarm 1138 comprising a buzzer, speaker, or other suitable sound-producing device as shown in FIGS. 18 and 22. Module I 100 may have a visual alarm other than LED's, such as one or more display screens, in accordance with this disclosure.

According to one embodiment of sensor module 1100, if both sensors 1126 do not sense that the gas type is proper, then the gas LED 1132 shines red, LED's 1134, 1136 both shine green, relay 1130 is opened to indicate an alarm, relay 1128 remains closed, and the audible alarm 1138 is operated so as to emit a continuous wail. If only one of either of sensors 1126 does not sense that the gas type is proper and the other sensor 1126 senses that the gas type is proper, then gas LED 1132 shines amber, flow LED 1134 shines green, fault LED 1136 shines amber, relay 1130 remains closed, relay 1128 is opened to indicate an alarm, and the audible alarm 1138 is operated so as to emit an intermittent chirp. If both sensors 1126 do not sense that the gas flow is proper, then gas LED 1132 shines green, flow LED 1134 shines red, fault LED shines 1136 green, relay 1130 remains closed, relay 1128 is opened to indicate an alarm, and the audible alarm 1138 is operated so as to emit an intermittent chirp. If only one of either of sensors 1126 does not sense that the gas flow is proper and the other sensor 1126 senses that the gas flow is proper, then gas LED 1132 shines green, flow LED 1134 shines amber, fault LED 1136 shines amber, relay 1130 remains closed, relay 1128 is opened to indicate an alarm, and the audible alarm 1138 is operated so as to emit an intermittent chirp. If any other fault is sensed by the circuitry of module 1100, including software or hardware faults, then LED's 1132, 1134 shine green, fault LED 1136 shines amber, relay 1130 remains closed, relay 1128 is opened to indicate an alarm, and the audible alarm 1138 is operated so as to emit an intermittent chirp.

As previously mentioned, one or more remote alarm modules 1120 may be coupled electrically to the main gas alarm module 1100. As shown in FIG. 18, the electrical coupling between modules 1100, 1120 may be in accordance with an RS-485 communications protocol having a positive transmission line (Tx+), a negative transmission line (Tx−), and ground line (Gnd). Other electrical couplings, including twisted pair wire couplings, that operate according to other communications protocols are within the scope of this disclosure for electrically coupling modules 1100, 1120, as are wireless couplings of modules 1100, 1120.

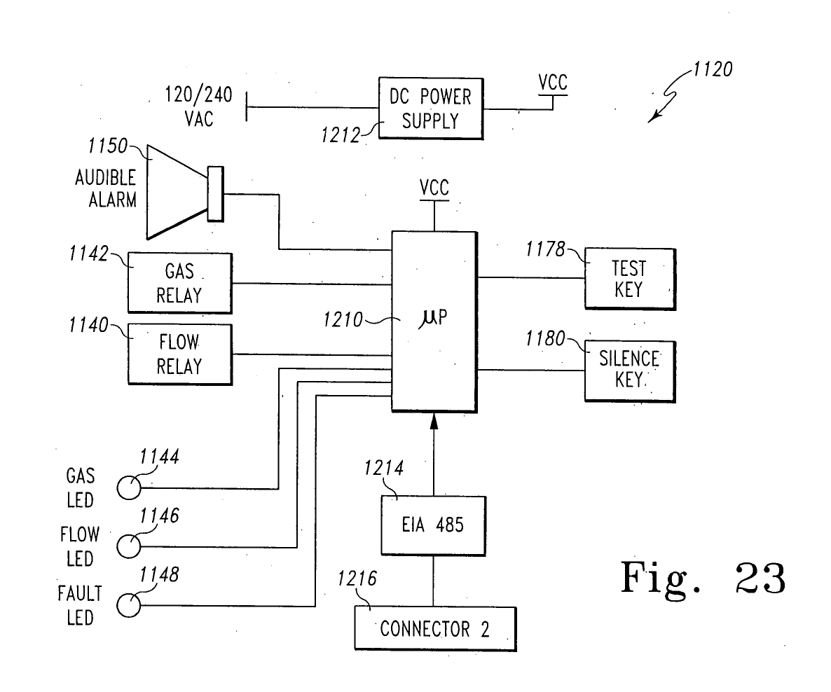

In the illustrative embodiment, remote gas alarm modules 1120 do not have sensors 1126, but rather serve as alarm repeaters throughout the healthcare facility. Modules 1120 have a flow relay 1140 and a gas relay 1142 as shown diagrammatically in FIGS. 18 and 23. Module 1120 has circuitry, discussed in further detail below in connection with FIG. 23, that normally closes relays 1140, 1142 when signals from module 1 100 indicate that the proper gas type and proper gas flow are sensed by module 1100. If an improper gas type is sensed by module 1100, then gas relay 1142 is opened at module 1120 to indicate an alarm condition. Similarly, if an improper gas flow is sensed by module 1100, then flow relay 1140 is opened at module 1120. Thus, the circuitry of sensor module 1120 is considered to be a supervised circuit in that relays 1140, 1142 are normally closed and are opened when an alarm condition is communicated to module 1120 from the associated module 1100. In alternative embodiments, module 1120 may be configured with a non-supervised circuit in which the relays are normally opened and are closed when an alarm condition is communicated to module 1120 from the associated module 1100.

Sensor module 1120 has a visual alarm comprising a gas LED 1144, a flow LED 1146, and a fault or alarm LED 1148 as shown in FIGS. 18, 20 and 23. In some embodiments, each of LED's 1144, 1146, 1148 are configured to shine with different colors, such as green, amber (i.e. yellow), or red, depending upon the signal applied thereto. In addition, sensor module 1120 has an audible alarm 1150 comprising a buzzer, speaker, or other suitable sound-producing device as shown in FIGS. 18 and 22.

According to one embodiment of sensor module 1120, if module 1100 communicates to module 1120 that both sensors 1126 do not sense that the gas type is proper, then the gas LED 1144 shines red, LED's 1146, 1148 both shine green, relay 1142 is opened to indicate an alarm, relay 1140 remains closed, and the audible alarm 1150 is operated so as to emit a continuous wail. If module 1100 communicates to module 1100 that only one of either of sensors 1126 does not sense that the gas type is proper and the other sensor 1126 senses that the gas type is proper, then gas LED 1144 shines amber, flow LED 1146 shines green, fault LED 1148 shines amber, relay 1142 remains closed, relay 1140 is opened to indicate an alarm, and the audible alarm 1150 remains silent. If module 1100 communicates to module 1120 that both sensors 1126 do not sense that the gas flow is proper, then gas LED 1144 shines green, flow LED 1146 shines amber, fault LED shines 1148 green, relay 1142 remains closed, relay 1140 is opened to indicate an alarm, and the audible alarm 1150 remains silent. If module 1100 communicates to module 1120 that only one of either of sensors 1126 does not sense that the gas flow is proper and the other sensor 1126 senses that the gas flow is proper, then gas LED 1144 shines green, flow LED 1146 shines amber, fault LED 1148 shines amber, relay 1142 remains closed, relay 1140 is opened to indicate an alarm, and the audible alarm 1150 remains silent. If module 1120 determines that it is not receiving communications from module 1100, then LED's 1144; 1146 shine green, fault LED 1148 shines amber, relay 1142 remains closed, relay 1140 is opened to indicate an alarm, and the audible alarm 1150 is operated so as to emit an intermittent chirp, where each chirp is a small chirp that is shorter in duration than the chirps emitted by audible alarm 1138 of module 1100. If any other fault is sensed by the circuitry of module 1120, including software or hardware faults, then LED's 1144, 1146 shine green, fault LED 1148 shines amber, relay 1142 remains closed, relay 1140 is opened to indicate an alarm, and the audible alarm 1150 remains silent.

Although, modules 1120 are considered to be repeaters of the alarms sensed by module 1100, a comparison of the previous paragraph pertaining to the manner of operation of relays 1140, 1142, LED's 1144, 1146, 1148, and audible alarm 1150 of module 1 120 with the earlier similar paragraph pertaining to the manner of operation of relays 1128, 1130, LED's 1132, 1134, 1136, and audible alarm 1138 of module 1100, shows that the visual and audible alarms are not exactly the same but there is still some indication of each of the various alarm conditions at the remote gas alarm modules 1120 when the associated main gas alarm module 1100 senses each of the various alarm conditions. It should be noted that the chirps of the audible alarms 1138, 1150 may have different patterns to indicate different alarm conditions, if desired. For example, one alarm condition may be indicated by two chirps and then a long pause, whereas another alarm condition may be indicated by three chirps and then a long pause, and so on. Furthermore, in addition to changing from green to amber or red, any of LED's 1132, 1134, 1136, 1144, 1146, 1148 may flash amber or red if alarm conditions exist.

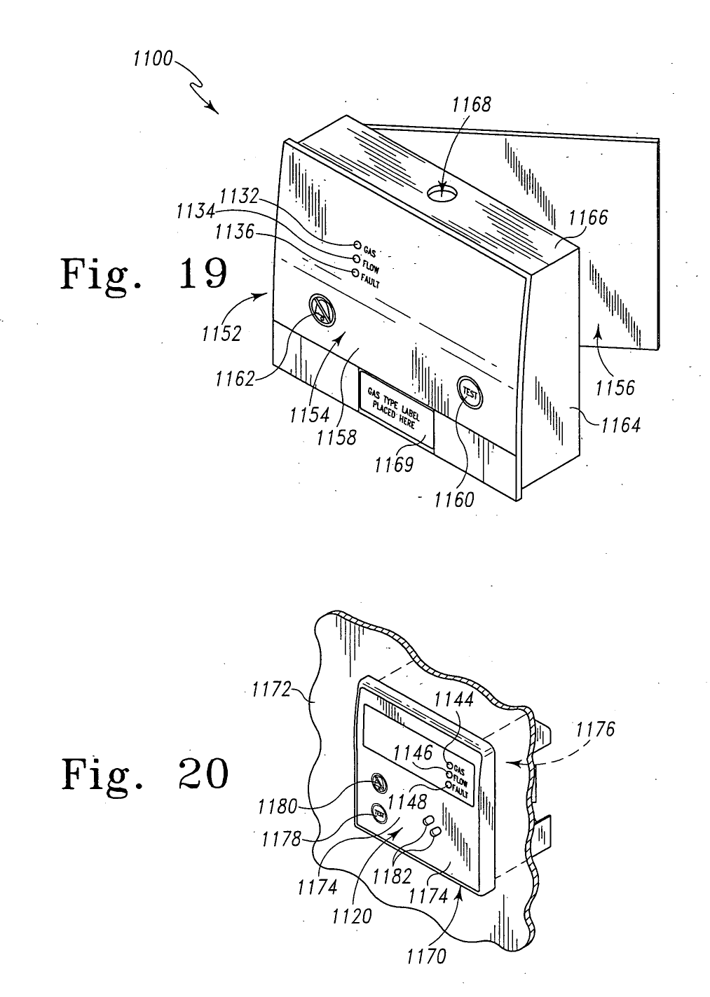

Referring now to FIG. 19, a housing 1152 of sensor module 1100 has a main housing portion 1154 and a back panel 1156 that opens and closes relative to portion 1154. In some embodiments, panel 1156 may be coupled to portion 1154 via one or more hinges (not shown). Module 1100 may be provided with suitable locks or couplers to lock or retain, respectively, panel 1156 in the closed position relative to portion 1154. Module 1100 may be located outside the healthcare facility, such as, for example, if module 1100 is coupled to a line leading from a manifold associated with one or more liquid oxygen tanks which are oftentimes located outside the healthcare facility. Thus, in some embodiments, housing 1152 is configured to be weatherproof so as to withstand exposure to rain, snow, hail, sleet, high winds, etc. A gasket or other suitable seal may be provided between panel 1156 and portion 1154 of housing 1152 as part of the weatherproofing of housing 1152.

The interior region of housing 1152 contains the circuit components of module 1100. In the illustrative embodiment, front panel 1158 of portion 1154 has apertures in which LED's 1132, 1134, 1136 are situated or through which LED's 1132, 1134, 1136 may be viewed. Also in the illustrative embodiment, front panel 1158 of portion 1154 has a test button 1160 and an alarm silence button 1162. Buttons 1160, 1162 may be configured as membrane switches, if desired, to reduce the probability of water leakage into the interior region of housing 1152. Pressing test button 1160 causes the circuitry of module 1100 to run a self-diagnostic test, which may include testing the operation of the visual and audible alarms as well as testing the operability of other circuit components and software operation. Pressing the alarm silence button 1162 when an audible alarm is sounding causes the audible alarm to turn off or become silent. In alternative embodiments, one or more of LED's 1132, 1134, 1136 and/or one or more of buttons 1160, 1162 may be located on portions of housing 1152, such as on a side panel 1164 or a top panel 1166.

In the illustrative embodiment, top panel 1166 of housing 1153 has an opening 1168 through which power and data lines may be routed. Appropriate sealing mechanisms may be provided between the power and data lines, or the conduit in which these lines may be situated, and top panel 1166. A fitting (not shown) is coupled to the bottom panel (not shown, but similar to top panel 1166) of housing 1152 and is configured to mate with a companion DISS fitting to couple module 1100 to the medical gas alarm system 1110 to be monitored. A label indicating the gas type to be monitored by module 1100 may be attached to an area 1169 of front panel 1158, if desired.

Referring now to FIG. 20, a housing 1170 of sensor module 1120 is configured to mount to a wall or panel 1172, such as room wall, a panel of a headwall unit, a wall of a column, or a wall of another structure in a healthcare facility, which is provided with an appropriately sized hole or recess to accept module 120. The outer peripheral region of a front panel 1174 of housing 1170 extends outwardly from a main housing portion 1176 of housing 1170. The interior region of housing 1170 contains the circuit components of module 1100. In the illustrative embodiment, front panel 1174 of portion 1154 has apertures in which LED's 1144, 1146, 1148 are situated or through which LED's 1144, 1146, 1148 may be viewed. Also in the illustrative embodiment, front panel 1174 of housing 1170 has a test button 1178 and an alarm silence button 1180. Buttons 1178, 1180 may be configured as membrane switches, if desired.

Pressing test button 1178 causes the circuitry of module 1120 to run a self-diagnostic test, which may include testing the operation of the visual and audible alarms as well as testing the operability of other circuit components and software operation. Pressing the alarm silence button 1180 when an audible alarm is sounding causes the audible alarm to turn off or become silent. Front panel 1174 of housing 1170 has a pair of apertures 1182 adjacent the audible alarm 1150 to reduce the attenuation by front panel 1174 of sound from the audible alarm 1150. In alternative embodiments, housing 1170 of module 1120 may be configured differently and one or more of LED's 1144, 1146, 1148 and/or one or more of buttons 1178, 1180 maybe located on portions of the alternative housing other than the front panel. A label indicating the gas type to be monitored by module 1120 may be attached to front panel 1174, if desired.

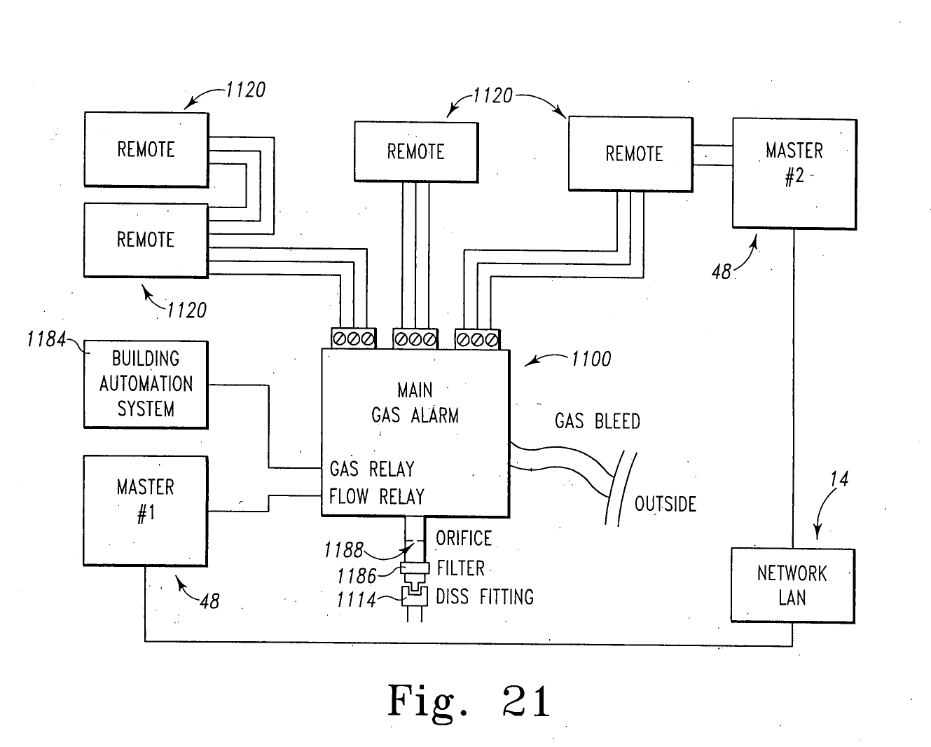

Sensor module 1100 and the associated remote gas alarm modules 1120 may be configured in a variety of system architectures such as the example shown diagrammatically in FIG. 21. Modules 1120 may be arranged in star patterns or chain patterns or in a combination of the two relative to the associated module 1100. If desired, one or both relays 1128, 1130 of module 1100 and one or both relays 1140, 1142 of any of modules 1120 may be coupled to a master alarm controller 48 and/or to a building automation system. In the example of FIG. 21, the gas relay 1130 of module 1100 is coupled building automation system 1184, the flow relay 1128 of module i 100 is coupled to a first master alarm controller 48, and both relays 1140, 1142 of one of the remote gas alarm modules 1120 is coupled to a second master alarm controller 48. If desired and if the master alarm controllers are of the type that are capable of communicating via the Ethernet of the healthcare facility (such as illustrative master alarm controllers 48), then master alarm controllers 48 may be coupled the network 14 as shown in FIG. 21. Again, the system architecture shown in FIG. 21 is but one example and there are practically an unlimited number of configurations that modules 1100, 1120 may be connected to one another and, if desired, to master alarm controllers, building automation system, and/or a computer network.

In the illustrative embodiment, relays 1128, 1130, 1140, 1142 provide binary signals via twisted pair wires to master alarm controllers 48 in the same manner as described above in connection with the switches that indicate various alarm conditions in source equipment 18 to master alarm controllers 48. In alternative embodiments, any of modules 1100, 1120 may be configured with communications circuitry similar to that of area alarm controllers 50, described above. Further alternatively, modules 1120 may be included in an area alarm controller 50 in a manner similar to modules 54, 554, described above, and may be configured to provide more sophisticated data than a binary signal to the communications circuitry of the associated area alarm controller 50. Thus, in some alternative embodiments, modules 1100, 1120 may generate data such as gas type, gas concentration, gas flow rate, serial number, software data, characteristic data, status data similar to modules 54 as described above.

As mentioned above, sensors 1126 of illustrative module 1100 are ultrasonic gas concentration sensors of the type manufactured by DigiFLO, Inc. In addition, illustrative module 1100 has a filter 186 and an orifice 1188 as shown diagrammatically in FIG. 21. Filter 1186 blocks debris from reaching orifice 1188 and orifice 1188 controls the volume flow rate of gas that is able to flow through sensors 1126. In one embodiment, filter 1186 is a 15 micron filter of the type available from O'Keefe Controls Company of Monroe, Connecticut and orifice 1188 is about 0.004 inch (0.01016 cm) in diameter which has been found to be suitable to provide a volume flow rate of about 0.3 liters of gas per minute at a pressure of about 40 p.s.i. (280 kPa). The performance of sensors 1126 may be degraded if an inappropriate volume flow rate of gas passes therethrough. Gas flowing through sensors 1126 bleeds to the ambient surrounding as indicated in FIGS. 21 and 22.

Referring now to FIG. 22, the circuitry of module 1100 includes a microprocessor 1190 that receives data from the circuitry 1192 associated with each of sensors 1126 via associated two wire buses 1194. In the illustrative embodiment, circuitry 1192 is provided by the manufacturer of sensors 1126 and includes its own microprocessor (not shown) and temperature compensation circuitry 1196. Each bus 1194 has a first conductor that communicates gas concentration data to microprocessor 1190 and a second conductor that communicates gas flow data to microprocessor 1190. When the data received by microprocessor 1194 from one or both of circuits 1192 indicates an alarm condition, microprocessor 1194 may query circuits 1192 to resend the data to confirm the alarm condition. Thus, microprocessor 1190 and the microprocessors of circuits 1192 provide module 1100 with redundant decision making regarding, alarm conditions in addition to having redundant sensors 1126.

Microprocessor 1190 receives signals from buttons 1160, 1162 to indicate the pressing of buttons 1160, 1162, respectively. In addition, microprocessor 1190 controls the operation of relays 1128, 1130, LED's 1132, 1134, 1136, and audible alarm 1138. Module 1100 has power circuitry 1198 that converts standard 120 VAC or 240 VAC, as the case may be, to usable DC voltages for use by the various circuit components of module 1100, such as microprocessor 1190 as shown in FIG. 22. Additional circuitry (not shown), such as current-limiting resistors associated with LED's 1132, 1134, 1136, transistors associated with power application to relays 1128, 1130, ground couplings, noise-attenuation capacitors, oscillators for microprocessor 1190 and the like are omitted from the block diagram of FIG. 22 but are included in the circuitry of module 1100 as will be appreciated by those skilled in the art.

Module 1100 also has communications circuitry 1200 that supports the communication of data from microprocessor 1190 to one or more remote gas alarm modules 1120. In the illustrative embodiment, circuitry 1200 is configured to support the Electronics Industry Association (EIA) RS-485 communications protocol as shown in FIG. 22. In other embodiments having other communications protocols, including wireless communication, circuitry 1200 is configured accordingly. Illustrative module 1100 also has a connector 1202 for coupling to wires, cables, or the like that are routed from module 1100 to one or more modules 1120.

Referring now to FIG. 23, the circuitry of module 1120 includes a microprocessor 1210 that receives signals from buttons 1178, 1180 to indicate the pressing of buttons 1178, 1180, respectively. In addition, microprocessor 1210 controls the operation of relays 1140, 1142, LED's 1144, 1146, 1148, and audible alarm 1150. Module 1120 has power circuitry 1212 that converts standard 120 VAC or 240 VAC, as the case may be, to usable DC voltages for use by the various circuit components of module 1120, such as microprocessor 1210 as shown in FIG. 23. Additional circuitry (not shown), such as current-limiting resistors associated with LED's 1144, 1146, 1148, transistors associated with power application to relays 1140, 1142, ground couplings, noise-attenuation capacitors, oscillators for microprocessor 1210, and the like are omitted from the block diagram of FIG. 22 but are included in the circuitry of module 1120 as will be appreciated by those skilled in the art.

Module 1120 also has communications circuitry 1214 that supports the receipt of data by microprocessor 1210 from module 1100 and the communication of data from microprocessor 1210 to one or more other remote gas alarm modules 1120. In the illustrative embodiment, circuitry 1214 is configured to support the RS-485 communications protocol as shown in FIG. 23. In other embodiments having other communications protocols, including wireless communication, circuitry 1214 is configured accordingly. Illustrative module 1120 also has a connector 1216 for coupling to wires, cables, or the like that are routed to module 1120 from module 1100 and that are routed to one or more other modules 1120.

There are a plurality of advantages of the concepts of the present disclosure arising from the various features of the apparatus and methods described herein. It will be noted that alternative embodiments of the apparatus and methods of the present disclosure may not include all of the features described yet still benefit from at least some of the advantages of such features. Those of ordinary skill in the art may readily devise their own implementations of the apparatus and methods of the present disclosure that incorporate one or more of the features of the present disclosure and fall within the spirit and scope of the invention defined by the appended claims.

1. A gas sensor module that is coupled to a gas conduit of a medical gas system in a healthcare facility and that operates to sense whether a type of gas in the gas conduit is a proper type of gas.

2. The gas sensor module of claim 1, wherein the module is located remotely from a set of source equipment of the medical gas system.

3. The gas sensor module of claim 1, wherein the module is mounted to the gas conduit behind a wall of the healthcare facility.

4. The gas sensor module of claim 1, wherein the module is mounted to the gas conduit above a ceiling of the healthcare facility.

5. The gas sensor module of claim 1, wherein the module is mounted to the gas conduit beneath a floor of the healthcare facility.

6. The gas sensor module of claim 1, wherein the module comprises a circuit including a gas sensor having a ceramic zirconia electrolyte material.

7. The gas sensor module of claim 1, wherein the module comprises a circuit including a gas sensor that senses a concentration of the gas based on an amount of time that ultrasonic sound waves propagate through a cavity containing a sample of gas from the gas conduit.

8. The gas sensor module of claim 1, wherein a sample of gas from the gas conduit flows through the module and exhausts to ambient atmosphere.

9. The gas sensor module of claim 1, wherein the module communicates an alarm signal to an alarm controller of a medical gas alarm system that monitors one or more conditions of the medical gas system.

10. The gas sensor module of claim 1, wherein the module activates an audible alarm when the gas type in the gas conduit is an improper type of gas.

11. A gas sensor module that is configured to couple to a service outlet of a medical gas system in a healthcare facility and that operates to sense whether a type of gas extant in a gas conduit coupled to the service outlet is a proper type of gas.

12. The gas sensor module of claim 11, wherein the module has a housing and a barrel extending from the housing, the barrel is configured for receipt in a port of the service outlet, and receipt of the barrel in the port opens a valve assembly of the service outlet to permit gas from the gas conduit to flow into the housing through the barrel.

13. The gas sensor module of claim 12, further comprising keys extending from the housing, the keys being configured for receipt in key-receiving apertures formed in the service outlet, and the valve assembly remaining closed during insertion of the barrel into the port of the service outlet until the keys are received in the key-receiving apertures.

14. The gas sensor module of claim 11, wherein gas from the gas conduit flows into the module through the service outlet and then exhausts to ambient atmosphere after flowing into contact with a gas sensor of the module.

15. The gas sensor module of claim 11, wherein the module comprises a housing, a circuit, and a test button that is coupled to the housing and that is pressed to test the circuit.

16. The gas sensor module of claim 11, wherein the module comprises a circuit including a light emitting diode that provides a visual indicator of an alarm condition that occurs when the type of gas in the gas conduit is an improper type of gas.

17. The gas sensor module of claim 1 1, wherein the module is configured to provide a feed-through service outlet to which an equipment connector is able to couple so that at least some of the gas flowing from the gas conduit into the module from the service outlet is thereafter able to flow out of the module and into the connector coupled to the module.

18. The gas sensor module of claim 17, wherein the module has a housing and a first barrel extending from the housing, the first barrel is configured for receipt in a first port of the service outlet, and receipt of the first barrel in the first port opens a first valve assembly of the service outlet to permit gas from the gas conduit to flow into the housing through the first barrel.

19. The gas sensor module of claim 18, wherein the feed-through service outlet comprises a second port formed in the housing, the connector has a second barrel configured for receipt in the second port, and receipt of the second barrel in the second port opens a second valve assembly that is situated in the housing of the module to permit gas from the housing to flow into the connector through the second barrel.

20. The gas sensor module of claim 19, wherein the housing of the module is configured for keyed coupling to the service outlet and the connector is configured for keyed coupling to the housing of the module.

21. The gas sensor module of claim 11, wherein the module is configured for keyed coupling to the service outlet.

22. An integrated service outlet and gas sensor module coupled to a gas conduit of a medical gas system in a healthcare facility, the module being coupleable to a connector of a piece of equipment to provide gas from the gas conduit to the piece of equipment, and the module having circuitry that is operable to sense whether the gas from the gas conduit is a proper type of gas.

23. The integrated service outlet and gas sensor module of claim 22, wherein the module comprises a housing having a port formed therein, the port is configured for receipt of a barrel of the connector, and receipt of the barrel of the connector in the port opens a valve assembly of the module to permit gas from the gas conduit to flow into the connector through the module.

24. The integrated service outlet and gas sensor module of claim 23, wherein the housing has one or more key-receiving apertures formed therein and the one or more key-receiving apertures are configured for receipt of respective keys of the connector, and the valve assembly remains closed during insertion of the barrel into the port of the housing until the one or more keys are received in the respective key-receiving apertures.

25. The integrated service outlet and gas sensor module of claim 22, wherein the module is configured for keyed coupling of the connector.

26. The integrated service outlet and gas sensor module of claim 22, wherein the circuitry includes a gas sensor and the module includes a diverter that diverts some of the gas from the gas conduit to flow through the gas sensor and then exhaust to ambient atmosphere.

27. The integrated service outlet and gas sensor module of claim 22, further comprising a test button that is pressed to test the circuitry.

28. The integrated service outlet and gas sensor module of claim 22, wherein the circuitry includes a light emitting diode that provides a visual indicator of an alarm condition that occurs when the type of gas in the gas conduit is an improper type of gas.

29. An apparatus for monitoring a gas extant in a gas pipe of a healthcare facility, the apparatus comprising
a housing;
a sensor carried by the housing and coupled pneumatically to the gas pipe, the sensor producing a sensor signal indicative of the type of gas extant in the gas pipe; and
a circuit carried by the housing and coupled electrically to the sensor, the circuit processing the sensor signal and producing an alarm signal if the gas extant in the gas pipe is an improper type of gas.

30. An apparatus for monitoring a gas that is available for delivery through a gas service outlet which is accessible in a room of a healthcare facility, the apparatus comprising
a gas sensor;
a circuit coupled to the gas sensor and operable to monitor the type of gas to which the gas sensor is exposed; and
a housing carrying the circuit and the gas sensor, the housing being adapted to be coupled to the service outlet.

31. The apparatus of claim 30, wherein the housing is adapted to be coupled to the medical equipment.

32. An apparatus for dispensing to healthcare equipment a gas from a gas pipe of a medical gas system of a healthcare facility and for monitoring the gas dispensed, the apparatus comprising
a gas sensor,
a circuit coupled to the gas sensor,
a housing carrying the circuit and the gas sensor, the housing being coupled to the gas pipe, the housing being configured for coupling of healthcare equipment thereto to receive gas from the gas pipe that passes through the housing, a sample of the gas from the gas pipe being diverted to the gas sensor so that the circuit is able to monitor the type of gas diverted to the gas sensor.

33. A gas sensor module that is adapted to be coupled to a line of a medical gas system that is designated for delivery of a type of gas, the gas sensor module being adapted to monitor the type of gas flowing through the line, to determine whether the type of gas flowing through the line is the proper gas type, and to generate an alarm signal if the gas type is improper.

34. A gas alert for a medical gas system, the gas alert comprising
a main gas alarm module coupleable to a line adjacent a bulk supply of medical gas in a healthcare facility, the main gas alarm being adapted to sense whether the type of gas flowing through the line is the proper gas type, and
at least one remote gas alarm module that is located remotely from the main gas alarm module and that receives communications from the main gas alarm module indicative of an alarm condition sensed by the main gas alarm module.

35.-66. (canceled)
